(19) United States
(12) Patent Application Publication
(10) Pub. No.: US 2020/0012008 A1
(43) Pub. Date: Jan. 9, 2020

(54) PARITY-TIME (PT)-SYMMETRIC WIRELESS TELEMETRIC SENSORS AND SYSTEMS

(71) Applicant: WAYNE STATE UNIVERSITY, DETROIT, MI (US)

(72) Inventors: PAI-YEN CHEN, DETROIT, MI (US); MARYAM SAKHDARI, DETROIT, MI (US); MEHDI HAJIZADEGAN, DETROIT, MI (US); MARK MING-CHENG CHENG, DETROIT, MI (US)

(21) Appl. No.: 16/504,664

(22) Filed: Jul. 8, 2019

Related U.S. Application Data
(60) Provisional application No. 62/695,133, filed on Jul. 8, 2018.

(51) Int. Cl. G01V 3/10; G01D 5/20; G01N 27/02

(52) U.S. Cl. CPC G01V 3/101; G01N 27/025; G01D 5/2066

(57) ABSTRACT

A sensor system includes a sensor that includes a RLC tank having a first input impedance. The RLC tank includes a first coupling inductor. The sensor system also includes a reader that includes a -RLC tank having a second input impedance. Characteristically, the -RLC tank includes a second coupling inductor inductively coupled to the first coupling inductor wherein the first input impedance multiplied by i is approximately equal to the complex conjugate of the second input impedance multiplied by i at one or more predetermined frequencies.

### CROSS-REFERENCE TO RELATED APPLICATIONS

This application claims the benefit of U.S. provisional application Ser. No. 62/695,133 filed Jul. 8, 2018, the disclosure of which is hereby incorporated in its entirety by reference herein.

### STATEMENT REGARDING FEDERALLY SPONSORED RESEARCH OR DEVELOPMENT

This invention was made with Government support under ECCS1711409 awarded by National Science Foundation. The Government has certain rights in the invention

### TECHNICAL FIELD

In at least one aspect, the present invention is related to, sensors with improved sensitivity and noise reduction.

### BACKGROUND

The wireless monitoring of physical, chemical and biological quantities is essential in a range of medical and industrial applications in which physical access and wired connections would introduce significant limitations. Examples include sensors that are required to operate in harsh environments, and those that are embedded in, or operate in the vicinity of, human bodies¹. Telemetric sensing based on compact, batteryless wireless sensors is one of the most feasible ways to perform contactless continuous measurements in such applications. The first compact passive wireless sensor was proposed in 1967², and used a miniature spiral inductor (L) and a pressure-sensitive capacitor (C) to build a resonant sensor that could measure the fluid pressure inside the eye (an intraocular pressure sensor). The idea was based on a mechanically adjusted capacitor (or varactor), which has been an effective way of tuning resonant circuits since the advent of the radio³. Despite this, wireless capacitive sensing technology has experienced a rapid expansion only in the last two decades, due to the development of microelectromechanical systems (MEMS), nanotechnology and wireless technology⁸.

Recently, low-profile wireless sensors based on passive LC oscillating circuitry (typically a series RLC tank) have been used to measure pressure^{5,6}, strain⁷, drug delivery⁸, temperature, and chemical reactions¹. The working principle of these passive LC sensors is typically based on detecting concomitant resonance frequency shifts, where the quantity to be measured detunes capacitive or inductive elements of the sensor. This could occur, for example, through mechanical deflections of electrodes, or variations of the dielectric constant. In general, the readout of wireless sensors relies on mutual inductive coupling (FIG. 1A), and the sensor information is encoded in the reflection coefficient. Such telemetric sensor systems can be modelled using a simple equivalent circuit model, in which the compact sensor is represented by a series resonant RLC tank, where the resistance R takes into account the power dissipation of the sensor (FIG. 1A).

Although there has been continuous progress in micro- and nano-machined sensors in recent years, the basics of the telemetric readout technique remain essentially unchanged since its invention. Nonetheless, improving the detection limit is often hindered by the available levels of Q-factor, the sensing resolution and the sensitivity related to the spectral shift of resonance in response to variations of the physical property to be measured. In particular, modern LC microsensors based on thin-film resonators or actuators usually have a low modal Q-factor, due to relevant power dissipations caused by skin effects, Eddy currents and the electrically lossy surrounding environment (such as biological tissues)⁹. A sharp, narrowband reflection dip has been a long-sought goal for inductive sensor telemetry, because it could lead to superior detection and great robustness to noises.

### SUMMARY

In at least one aspect, a generalized parity-time (PT)-symmetric telemetric sensing technique is provided. This sensing technique enables new mechanisms to manipulate radiofrequency (RF) interrogation between the sensor and the reader, to boost the effective Q-factor and sensitivity of wireless microsensors in terms of the resonance frequency shift or phase/impedance variations.

In another aspect, his sensing technique is implemented using MEMS-based wireless pressure sensors operating in the RF spectrum.

In at least one aspect, the present invention solves one or more problems of the prior art by providing a sensor system that utilizes PT symmetry for improved performance. The sensor system includes a sensor that includes a RLC tank having a first input impedance. The RLC tank includes a first coupling inductor. The sensor system also includes a reader that includes a -RLC tank having a second input impedance. Characteristically, the -RLC tank includes a second coupling inductor inductively coupled to the first coupling inductor wherein the first input impedance multiplied by i is approximately equal to the complex conjugate of the second input impedance multiplied by i at one or more predetermined frequencies.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIGS. 1A and 1B. Generalized PT-symmetric telemetric sensor system. A, Schematic diagrams of a typical wireless implantable or wearable sensor system, where a loop antenna used to interrogate the sensor via inductive (magnetic) coupling. The parameters to be sensed can be accessed by monitoring the reflection coefficient of the sensor, typically based on an RLC resonant circuit consisting of a micromachined variable capacitor (varactor) and inductor (sometimes, the role of varactor is replaced by a variable resistor). B, Equivalent circuit model for the proposed PTX-symmetric telemetric sensor system, where x is the scaling coefficient of the reciprocal-scaling operation X. If x=1, the PTX system converges to the PT-symmetric case. In the closed-loop normal mode analysis, an RF signal generator with a source impedance Z₀, connected to the reader, is represented by −Z₀. The inset shows the a.c. model for the Colpitts circuit with a positive feedback, which achieves an equivalent negative resistance and an equivalent series capacitance.

FIGS. 2A, 2B, 2C, and 2D. MEMS-based wireless pressure sensor. A, Schematic diagrams of a MEMS-based pressure sensor, which consists of a variable parallel-plate capacitor (C) connected in series with a microcoil inductor (L), effectively forming a resonant LC tank circuit. Increasing the internal pressure would increase the displacement of the upper membrane electrode, thereby reducing the capacitance of the MEMS varactor. B, Top view of the microfabricated wireless pressure sensor on a flexible polymer substrate. C, Three-dimensional surface profile of the sensor in Fig. B, which was measured by the scanning white light interferometry (SWLI). D, Measurement (dots) and theoretical (solid line) results for the total capacitance in response to pressure; the insets show the displacement of the upper membrane electrode measured by the SWLI. Due to the cylindrical symmetry of the capacitor, only displacements in the radial direction (from point A to point B in Fig. C) are shown.

FIGS. 3A-1, 3A-2, 3B-1, 3B-2, and 3C. Evolution of eigenfrequencies and reflection spectra as a function of the non-Hermiticity parameter γ (γ=R⁻¹(L/C)^{1/2}) and coupling strength κ (M/L and M is the mutual inductance). A,B, Real (a, left) and imaginary (a, right) eigenfrequency isosurface normalized by ω0 in the (γ,κ) parameter space for a PT-symmetric wireless pressure sensor and a conventional passive wireless pressure sensor (B), where an active reader and a passive loop antenna are respectively used to interrogate the micromachined sensor in FIG. 2. C, Reflection spectra against the frequency for the PT-symmetric wireless pressure sensor with different coupling strengths, showing a transition from the broken PT-symmetric phase (κ=0.4) to the exact PT-symmetric phase (κ=0.48, 0.49 and 0.5) when κ increases; here γ=2.26, corresponding to an applied pressure of 100 mmHg, and ω₀/2π=180 MHz. The frequencies and linewidths of the reflection dips in c are consistent with the eigenfrequency evolution in A. The solid and dashed lines denote experimental data and theoretical results obtained from the equivalent circuit model in FIG. 3.

FIGS. 4A and 4B. Pressure-induced spectral changes for conventional and PT-symmetric telemetric sensors. A,B, The magnitude of the reflection coefficient for the MEMS-based pressure sensor (FIG. 2) interrogated by the conventional passive loop antenna (A) and the active reader realizing a PT-symmetric dimer (B), under different applied pressures. The solid and dashed lines denote experimental data and theoretical results obtained from the equivalent circuit model.

FIGS. 5A, 5B, and 5C. Evolution of the eigenfrequencies and reflection spectra for PTX-symmetric telemetric sensors. A, Real (left) and imaginary (right) eigenfrequency as a function of the non-Hermiticity parameter γ for the fully passive (red open circles; FIG. 6A), PT-symmetric (blue dots; FIG. 7B) and PTX-symmetric (green and yellow symbols; B and C) telemetric pressure sensors. The solid lines denote theoretical predictions (see Methods). B,C, The magnitude of the reflection coefficient for the PTX-symmetric telemetric sensor systems; here, the scaling coefficients x used in B and C are 3 and ⅓. The solid and dashed lines in b and c denote the experimental data and theoretical predictions.

FIG. 6. Maximum displacement of the movable electrode against applied pressure for the MEMS varactor in FIG. 2 of the main text.

FIG. 7. Capacitance against the applied pressure for the MEMS varactor in FIG. 2 of the main text.

FIG. 8. Configurations and physical parameters of planar coils used in the reader and the sensor.

FIGS. 9A, 9B, 9C, 9D, and 9E. (A) Schematics of the reader circuit for the PT/PTX-symmetric telemetric sensors, consisting of a negative resistance converter (Colpitts oscillator) connected to a micro-coil inductor, fed by a RF source (vector network analyzer; VNA). (B) Input impedance of an open-circuited Colpitts-type circuit Zin=vi/ii, without connecting to any reactive element. The complex input impedance can be decomposed into a series combination of an equivalent negative resistance −Req and an equivalent capacitance Ceq. (C) Equivalent circuit model for the PT/PTX-symmetric telemetric sensor system, in which the reader is a series -RLC tank where -R and C are contributed by the Colpitts-type oscillator. (D) Layout and (E) fabricated PCB-based active reader used in the PT-symmetric sensor.

FIGS. 10A, 10B, and 10C. (A) Reflection spectra of the NRC versus frequency under different biasing conditions; here, solid and dashed lines represent the experimental and simulation results, and dotted lines represent the simulation results without considering the parasitic capacitance. (B) Equivalent resistance and (C) equivalent capacitance and parasitic components for the NRC in (A). The highlighted areas show the frequency range of interest, where the values of negative resistance and capacitance are nearly constant. The effects of Lₚ and Cₚ are negligible if the operating frequency is much lower than the cutoff frequency of the transistor.

FIG. 11. Schematics of fabrication processes for the MEMS-based intraocular pressure sensor in FIG. 2 in the main text.

FIG. 12. Variations of eigenfrequencies with the pressure-driven capacitance for conventional and PT-symmetric wireless pressure sensor systems. The pressure corresponding to the specific capacitance can be found in FIG. 5. We note that PT- and PTX-symmetric sensors display the same resonance frequency shift in response to sensor's impedance perturbation because they share the same eigenspectrum.

FIG. 13. PTX-symmetric electronic system realized with the parallel-circuit configuration.

FIGS. 14A, 14B, 14C, and 14D. (A) PTX-symmetric circuits with the RF excitation source connected to the active -RLC tank. (B) Reflection spectrum for the single-port circuit in (A), under different values of x. (c) PTX-symmetric circuits with the RF excitation source connected to the passive RLC tank; the circuits in (A) and (C) share the same eigenfrequencies, as they represent the same type of -RLC/RLC dimer in the coupled-mode analysis. (D) Reflection spectrum for the single-port circuit in (a), under different values of y. In the PTX-symmetric circuit, resonant frequencies remain constant, while the bandwidth (or Q-factor) can be tailored by varying the scaling coefficient x or y.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Throughout this application, where publications are referenced, the disclosures of these publications in their entireties are hereby incorporated by reference into this application to more fully describe the state of the art to which this invention pertains.

“i” means the square root of −1.

In general, sensor systems that utilize PT and PTX symmetry to enhance sensitivity and reduce noise are provided. Details of this systems are provided in Generalized parity-time symmetry condition for enhanced sensor telemetry, Pai-Yen Chen, Maryam Sakhdari, Mehdi Hajizadegan, Qingsong Cui, Mark Ming-Cheng Cheng, Ramy El-Ganainy and Andrea Alù, Nature Electronics 1, pages 297-304 (2018); Sensitivity Enhancement by Parity-Time Symmetry in Wireless Telemetry Sensor Systems, Pai-Yen Chen, 32nd URSI GASS, Montreal, 19-26 Aug. 2017; Ultrasensitive Telemetric Sensor Based on Adapted Parity-Time Symmetry, Maryam Sakhdari and Pai-Yen Chen, in: 2017 IEEE International Symposium on Antennas and Propagation & USNC/URSI National Radio Science Meeting, Date of Conference: 9-14 Jul. 2017, Date Added to IEEE Xplore: 19 Oct. 2017, Electronic ISSN: 1947-1491, INSPEC Accession Number: 17281014, DOI: 10.1109/APUSNCURSINRSM. 2017.8072332; Ultrasensitive, Parity-Time-Symmetric Wireless Reactive and Resistive Sensors, Maryam Sakhdari and Pai-Yen Chen, IEEE SENSORS JOURNAL, VOL. 18, NO. 23, Dec. 1, 2018, pages 9548-9555; and High-Sensitivity Wireless Displacement Sensing Enabled by PT-Symmetric Telemetry, Mehdi Hajizadegan, Maryam Sakhdari, Shaolin Liao, and Pai-Yen Chen, IEEE Transactions On Antennas And Propagation, Vol. 67, No. 5, MAY 2019 3445-3449; the entire disclosures of each of these publications and their published supplemental information are hereby incorporated in their entirety by reference herein. In one variation, the PT-symmetry condition is achieved when the gain and loss parameters, namely −R and R, are delicately balanced, and the reactive components, L and C, satisfy mirror symmetry. In this regard, the impedances of the active circuit tank (an active reader) and passive circuit tank (e.g., a microsensor) multiplied by i, are complex conjugates of each other at the frequency of interest. In another variation, the PTX-symmetry is achieved by suitably scaling the values of −R, L and C in the active reader. In this regard, the system can be made invariant under the combined parity transformation [symbol] (q₁↔q₂), time-reversal transformation [symbol] (t→−t) and reciprocal scaling χ(q₁→x^{1/2}q₁,q_{2→x}^{-1/2}q₂) where t is time, x is the reciprocal-scaling coefficient which is an arbitrary positive real number, q1 is the charge stored in the capacitor of the active circuit tank, and q2 is the charge stored in the capacitor of the passive circuit tank. In this context, R is the resistance component, C is the capacitance component, and L is the inductance which typically has different values for the sensor and reader tank circuits. It should also be appreciated that the active and passive tank circuits may include other resistors, capacitors, or inductors. Advantageously, the active reader further includes an RF generator such that the sensor can be monitored by reflection (via a reflection coefficient) of generated RF signals from the reader.

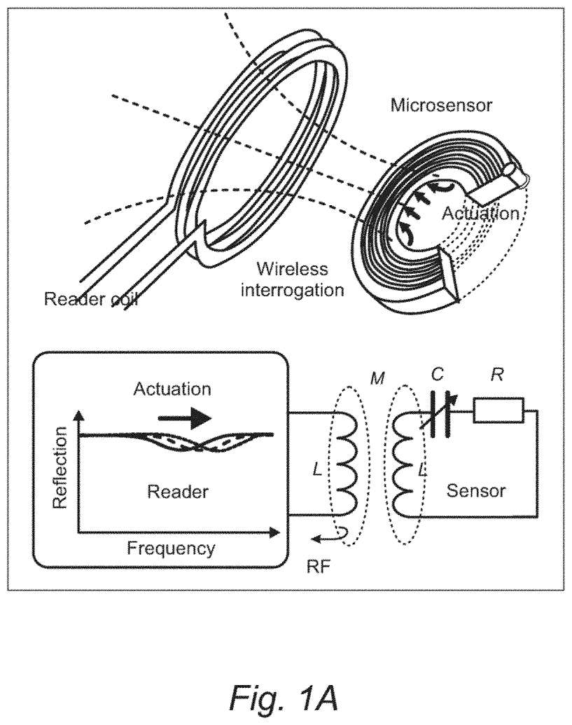

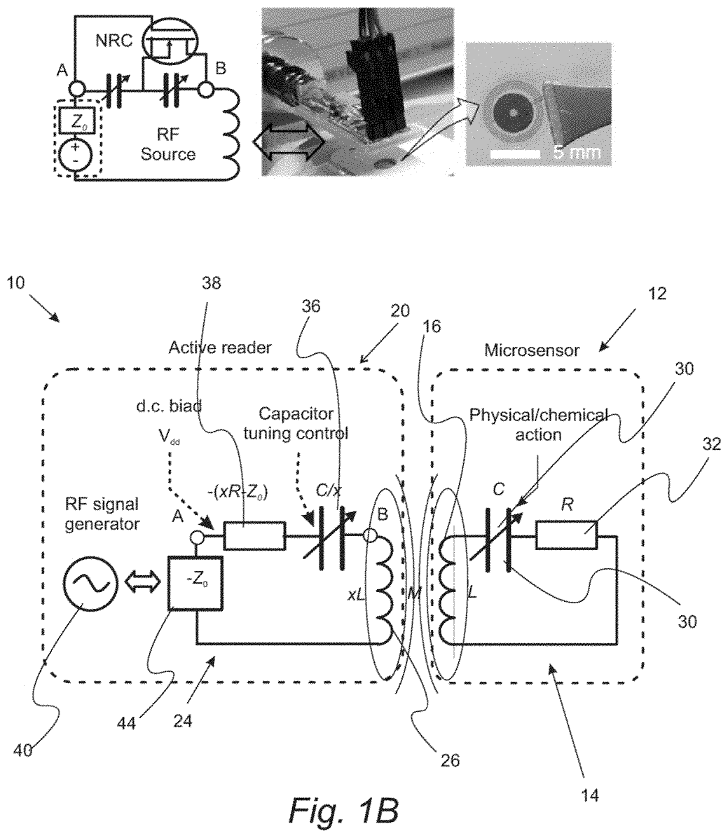

With reference to FIGS. 1A and 1B, a schematic illustration of a sensor system that utilized PT symmetry for improved performance is provided. Sensor system 10 includes sensor 12 that includes a RLC tank 14 having a first input impedance. RLC tank 14 includes a first coupling inductor 16. Sensor system 10 also includes reader 20 that includes -RLC tank 24 having a second input impedance. The -RLC tank 24 includes a second coupling inductor 26 inductively coupled to the first coupling inductor 16 wherein the first input impedance multiplied by i is approximately equal to the complex conjugate of the second input impedance multiplied by i at one or more predetermined (resonance) frequencies. In this regard, it should be appreciated that the system is a wireless system.

In a variation, RLC tank 14 further includes component 30 which can be a first variable capacitor or variable resistor (i.e. a capacitor is illustrate) in series with first coupling inductor 16. In a refinement, first variable capacitor can be a physical or chemical sensitive capacitor (e.g., pressure sensitive capacitor). When a variable resistor is used, the first variable resistor can be variable capacitor is a physical or chemical sensitive resistor. In a refinement, RLC tank 16 further includes a resistor and/or an effective resistance 32 in series with the first coupling inductor and the first variable capacitor.

In another variation, -RLC tank 24 further includes a second variable capacitor 36 in series with the second coupling inductor. In a refinement, -RLC tank 24 further includes a second resistor and/or an effective resistance 38 in series with the second coupling inductor 26 and the second variable capacitor. Typically, reader 20 also includes an RF generator 40 such that sensor 12 can be monitored by reflection (via a reflection coefficient) of generated RF signals from the reader.

Advantageously, sensor system 10 typically exhibits parity-time symmetry. In this regard, as set forth above, the first input impedance multiplied by i is approximately equal to the complex conjugate of the second input impedance multiplied by i at one or more predetermined frequencies. In a refinement, the first input impedance multiplied by i has a magnitude that is within 10 percent of a magnitude of the second input impedance. In other refinements, the first input impedance multiplied by i has a magnitude that is within, in increasing order of preference, 20 percent, 10 percent, 5 percent, or 1 percent of a magnitude of the second input impedance. In this regard, the phase of the first input impedance multiplied by i is within 10 percent of −1 times the phase of second input impedance multiplied by i. Furthermore, gain and load of the sensor system is balanced as set forth in more detail below. In a refinement, the gain is within 20 percent of the load.

In other variations, the sensor system 10 further exhibits parity time symmetry and reciprocal scaling (i.e., PTX symmetry) between the RLC tank and the -RLC tank. In this regard, second resistor and/or an effective resistance 38 includes a negative resistance component 44 in series with the second coupling inductor 26. Negative resistance component 44 can be any device that has a negative equivalent resistance. Negative resistance component 44 are illustrated in FIG. 1 and explained in more detail below. The theory behind the operation of the sensor system shows that the predetermined frequencies are eigenfrequencies of the sensor system.

It should be appreciated, that for active reader 20, the defining components for the PT-symmetric and the PTX-symmetric conditions are the impedance values of the second coupling inductor 26, second variable capacitor 36, and second resistor and/or an effective resistance 38 with a negative resistance component 44. Similarly, sensor 12, the defining components for the PT-symmetric and the PTX-symmetric conditions are the impedance values of the first coupling inductor 16, first variable capacitor 30, and first resistor and/or an effective resistance 32 with a negative resistance component 44. Moreover, the system operates in the proximity of the exceptional point which appears in PT-symmetric non-Hermitian systems. Advantageously, the sensor system has a superior sensitivity in terms of shifts in predetermined frequency when physical or chemical parameters of interest in or around the sensor are changed. Moreover, the sensor system has a high resolution due to large quality factor (Q-factor) measured in the reader.

As set forth above, the sensor system is typically a wireless sensor that is positionable externally (wearable) to a subject (e.g., a MEMS system). In some variation, the sensor is implantable in a subject.

The following examples illustrate the various embodiments of the present invention. Those skilled in the art will recognize many variations that are within the spirit of the present invention and scope of the claims.

Generalized PT-Symmetry

The concept of PT-symmetry was first proposed in the context of quantum mechanics¹⁰ and has been extended to classical wave systems, such as optics¹¹⁻¹³, owing to the mathematical isomorphism between Schrodinger and Helmholtz wave equations. PT-symmetric optical structures with balanced gain and loss have unveiled several exotic properties and applications, including unidirectional scattering^{14,15,} coherent perfect absorber-lasers^{16,17,} single-mode micro-ring lasers¹⁸⁻²⁰ and optical non-reciprocity²¹⁻²⁴. Inspired by optical schemes, other PT-symmetric systems in electronics (sub-RF, 30 kHz and below²⁵⁻²⁷), acoustics²⁸ and optomechanics^{29,30} have also been reported recently. The exceptional points arising in these systems, found at the bifurcations of eigenfrequencies near the PT-phase transition, show the potential to enhance the sensitivity of photonic sensors³¹⁻³⁵.

In principle, exceptional points and bifurcation properties of a PT-symmetric system can be utilized also to enhance sensor telemetry, represented by the equivalent circuit in FIG. 1B with x=1. In this case, the PT-symmetry condition is achieved when the gain and loss parameters, namely −R and R, are delicately balanced, and the reactive components, L and C, satisfy mirror symmetry: that is, the impedances of the active and passive circuit tanks, multiplied by i, are complex conjugates of each other at the frequency of interest. Similar to earlier experiments in optical systems²², the realization of PT-symmetry in a telemetric sensor system is expected to exhibit real eigenfrequencies in the exact symmetry phase. This leads to sharp and deep resonances, beyond the limitations discussed above for passive systems, thus providing improved spectral resolution and modulation depth for sensing. Despite this advantage of traditional PT-symmetric systems, practical implementations for the sensor telemetry may encounter difficulties in achieving an exact conjugate impedance profile. For instance, given the limited area of medical bioimplants and MEMS-based sensors, the inductance of the sensor's micro-coil L_{S} is usually smaller than the one of the reader's coil L_{R}. Although downscaling the reader coil can match L_{R} to L_{S}, this would reduce the mutually inductive coupling and degrade the operation of the wireless sensor. Therefore, it is highly desirable to have extra degrees of freedom that allow arbitrary scaling of the coil inductance and other parameters (for example, capacitance and equivalent negative resistance) in the reader, to optimize the wire-less interrogation and facilitate the electronic circuit integration.

To overcome these difficulties, and at the same time significantly improve the sensing capabilities of telemetric sensors, we also introduce here the idea of PTX-symmetric telemetry (FIG. 1B). This PTX-symmetric electronic system consists of an active reader (equivalently, a -RLC tank), wirelessly interrogating a passive micro-sensor (RLC tank) via the inductive coupling. Here, the equivalent series −R is achieved with a Colpitts-type circuit (FIG. 1B), which acts as a negative-resistance converter (NRC) (see the detailed design, analysis and characterization of the circuit set forth below). By suitably scaling the values of −R, L and C in the active reader, the system can be made invariant under the combined parity transformation [symbol] (q₁↔q₂), time-reversal transformation [symbol] (t→−t) and reciprocal scaling χ(q₁→x^{1/2}q₁,q₂→x^{-1/2}q₂) corresponds to the charge stored in the capacitor in the -RLC (RLC) tank and x is the reciprocal-scaling coefficient, an arbitrary positive real number. In the following analysis, we will prove that the introduced x transformation allows the operation of a system with unequal gain and loss coefficients (also an asymmetric reactance distribution), while exhibiting an eigenspectrum that is identical to the one of the PT-symmetric system. Crucially, the scaling operation X offers an additional degree of freedom in sensor and reader designs, overcoming the mentioned space limitations of microsensors that pose challenges in realizing PT-symmetric telemetry. Even more importantly, while the scaling provided by the x operator leaves the eigen spectrum unchanged, it leads to linewidth sharpening and thus boosts the extrinsic Q-factor, the sensing resolution and the overall sensitivity.

As we demonstrate below, the effective Hamiltonians of PTX and PT systems are related by a mathematical similarity transformation. We start by considering Kirchoff's law of the equivalent circuit representation of the PTX telemetric sensor system (FIG. 1B) cast in the form of a Liouville-type equation ∂_{τ}ψ= [symbol] Ψ (ref²⁵) governing the dynamics of this coupled RLC/-RLC dimer, where the Liouvillian [symbol] is given by

$$ℒ = ( \begin{matrix}0 & 0 & 1 & 0 \\ 0 & 0 & 0 & 1 \\ - \frac{1}{1 - {κ}^{2}} & \frac{1}{\sqrt{x}} \frac{κ}{1 - {κ}^{2}} & \frac{1}{γ ( 1 - {κ}^{2} )} & \frac{1}{\sqrt{x}} \frac{κ}{γ ( 1 - {κ}^{2} )} \\ \sqrt{x} \frac{κ}{1 - {κ}^{2}} & - \frac{1}{1 - {κ}^{2}} & - \sqrt{x} \frac{κ}{γ ( 1 - {κ}^{2} )} & - \frac{1}{γ ( 1 - {κ}^{2} )}\end{matrix} ) \qquad ( 1 )$$

and Ψ≡(q₁, q₂, \dot{q}₁, \dot{q}₂)^{T}, τ=ω₀t, the natural frequency of an isolated lossless LC tank ω₀=1/\sqrt{LC}, the coupling strength between the active and passive tanks κ=M/\sqrt{L_{R}L_{S}}, L_{R}=xL, L_{S}=L and the dimensionless non-Hermiticity parameter γ=R⁻¹=\sqrt{L/C}=(x|−R|)⁻¹\sqrt{(xL)/(C/x)}; here, all frequencies are measured in units of ω₀. The active and passive tanks have the same non-Hermiticity parameter γ, regardless of the value of x (PT or PTX system). From equation (1), we can define an effective Hamiltonian H=i [symbol] with non-Hermitian form (that is, H H^{†}≠H). Such a non-Hermitian Hamiltonian system is invariant under a combined PTX transformation, with

$$\begin{matrix}𝒫 = ( \begin{matrix}{σ}_{x} & 0 \\ 0 & {σ}_{x}\end{matrix} ) & ( 2 a ) \\ 𝒯 = ( \begin{matrix}1 & 0 \\ 0 & - 1\end{matrix} ) κ & ( 2 b ) \\ 𝒳 = 1 ⊗ {x}_{0} and {x}_{0} = ( \begin{matrix}{x}^{1 / 2} & 0 \\ 0 & {x}^{- 1 / 2}\end{matrix} ) & ( 2 c )\end{matrix}$$

where σₓ is the Pauli matrix, 1 is the identity matrix, [symbol] performs the operation of complex conjugation and ( [symbol] X)²=1. The Hamiltonian and eigenmodes of the PTX system are related to those of the PT system (H′, Ψ′) through the similarity transformation H=S⁻¹H′S and Ψ=S⁻¹Ψ′ where S is an invertible 4-by-4 matrix S=1⊗ζ and

$$ζ = ( \begin{matrix}{x}^{1 / 2} & 0 \\ 0 & 1\end{matrix} ) .$$

As a result, PTX and PT system s share the same eigenfrequencies, but possess different eigenmodes. Moreover, H commutes with transformed operators [symbol] =S⁻¹ [symbol] S and [symbol] =S⁻¹ [symbol] S= [symbol] , that is, [ [symbol] , [symbol] ]=0, where [symbol] performs the combined operations of parity and reciprocal scaling: x^{1/2}q₁,↔x^{-1/2}q₂. After some mathematical manipulations, we obtain [symbol] = [symbol] X, and, therefore, H commutes also with [symbol] X (that is, [ [symbol] X,H]=0). In the limit, when the scaling coefficient x=1, the [symbol] X-symmetric system converges into the traditional [symbol] -symetric system. Hence, the [symbol] X-symmetry can be regarded as a generalized group of the [symbol] -symmetry.

PT/PTX-Symmetric Telemetric Microsensor Systems

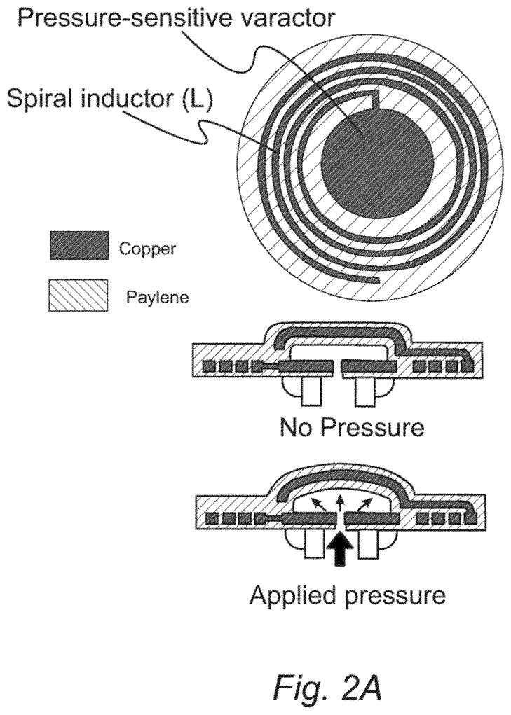

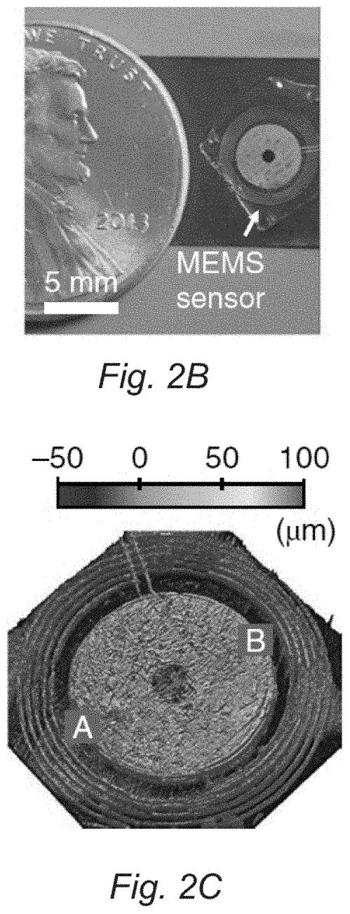

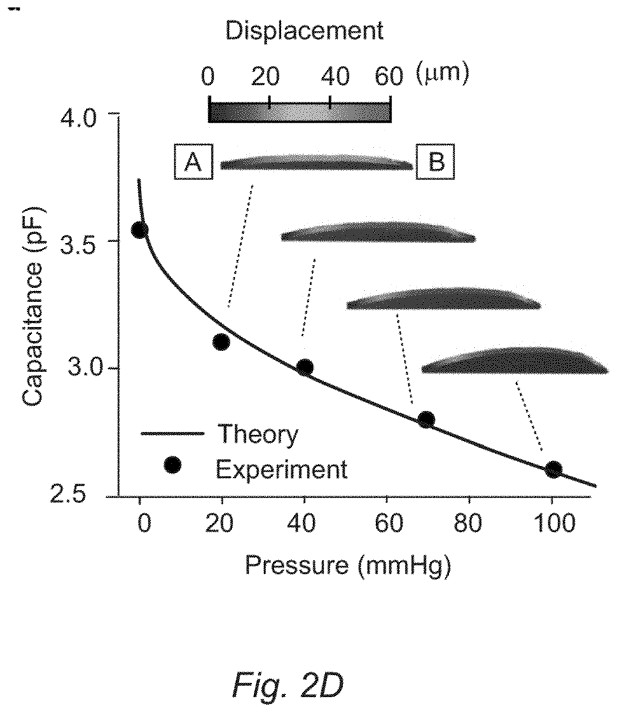

We designed and realized the sensor using a micromachined parallel-plate varactor connected in series to a micromachined planar spiral inductor and also a parasitic resistance (FIG. 1B). FIG. 2A-C shows schematic diagrams and a photograph of the realized device, together with its detailed surface profiles characterized by scanning white-light interferometry (SWLI) (see below for design and fabrication details). The sensor was encapsulated with epoxy polyamides and connected to an air compressor, and a microprocessor-controlled regulator was used to vary the internal pressure inside the MEMS microcavity from 0 mmHg to 200 mmHg. This procedure simulates, for instance, pressure variations inside the human eye⁶ (see Methods for the detailed measurement set-up). The sensor can be seen as a tunable passive RLC tank, in which the applied pressure mechanically deforms the floating electrode of the varactor (FIG. 2A), causing a change in the total capacitance. FIG. 2D presents the extracted capacitance as a function of the internal pressure, with insets showing the corresponding cross-sectional SWLI images (see below for the extraction of RLC values). The measurement results agree well with theoretical predictions, revealing that the capacitance is reduced by increasing the applied pressure.

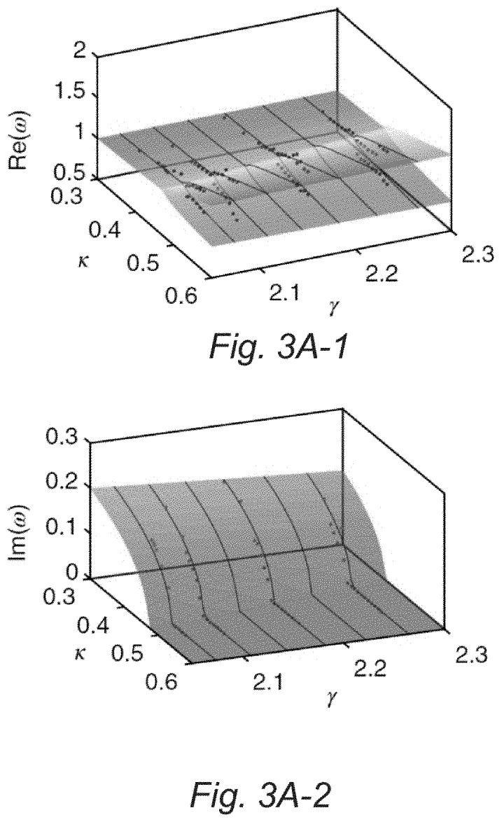

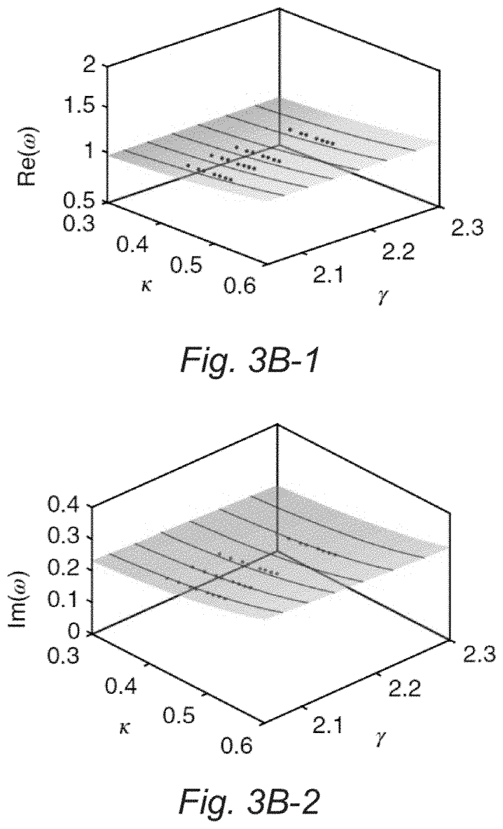

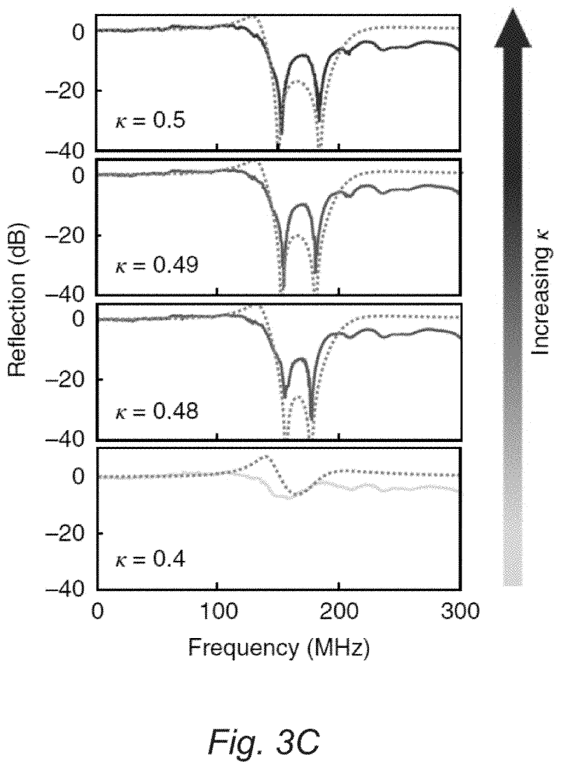

In our first set of experiments, we designed an active reader, which, together with the passive microsensor, forms the PT-symmetric dimer circuit. We investigate the evolution of complex eigenfrequencies and reflection spectra as we vary γ and K. In our measurements, the sensor was fixed on an XYZ linear translation stage used to precisely control K. For a specific value of κ, γ was tuned by the equivalent capacitance of the microsensor, responsible for the applied pressure. On the reader side, the voltage-controlled impedance converter provides an equivalent negative resistance, whose magnitude is set equal to −(R−Z₀), where the sensor's effective resistance R was measured to be ˜150Ω and Z₀ is the source impedance of the RF signal generator (for example, the vector network analyzer (VNA) used in the experiment, with Z₀=50Ω) connected in series to the active reader. We note that, in the closed-loop analysis, an external RF source can be modelled as a negative resistance −Z₀, as it supplies energy to the system³. When the sensor's capacitance changed, the voltage-controlled varactor in the reader circuit was adjusted accordingly to maintain the PT-symmetry condition (see below for details of reader design). Wireless pressure sensing was performed by monitoring in situ the shift of resonance in the reflection spectrum across 100-350 MHz. In our measurements, a clear eigenfrequency bifurcation with respect to γ and κ of the PT-symmetric system was observed (as shown in FIG. 3A) and the agreement between experimental results (dots) and theory (colored contours) is excellent; a detailed theoretical analysis of the critical points is provided in the Methods. At the exceptional point γ_{EP}, real eigenfrequencies branch out into the complex plane. In the region of interest γ∈[γ_{EP}, ∞], the eigenfrequencies are purely real (ω∈ [symbol] ) (FIG. 3A) and [symbol] Ψ′=Ψ′, such that the PT-symmetry condition is exactly met in the so-called exact PT-symmetric phase. In this phase, the oscillation occurs at two distinct eigenfrequencies corresponding to sharp reflection dips (Fig. C). Before passing γ_{EP}, the system is in its broken PT-symmetric phase, where complex eigenfrequencies (ω∈ [symbol] ) exist in the form of complex conjugate pairs, and the PT-symmetry of eigenmodes is broken, namely [symbol] Ψ′≠Ψ′. The system exhibits a phase transition when the non-Hermiticity parameter exceeds the critical value γ_{EP}, at which point the non-Hermitian degeneracy can unveil several counterintuitive features, such as the unidirectional reflectionless transparency^{14,28} and the singularity-enhanced sensing³¹⁻³⁵.

To better illustrate the system response, we plot the measured reflection spectra, where γ is fixed to 2.26 (corresponding to an applied pressure of 100 mmHg), while κ is continuously varied from 0.4 to 0.5 (FIG. 3C). The evolution of the resonant response clearly identifies the eigenfrequency transition (FIG. 3A). In the weak coupling region, the system operates in the broken PT-symmetric phase, quantified by κ<κ_{PT}, and its complex eigenfrequency results in a weak and broad resonance. This can be explained by the fact that, if the coupling strength is weak, the energy in the active -RLC tank cannot flow fast enough into the passive RLC tank to compensate for the absorption, thereby resulting in a non-equilibrium system with complex eigenfrequencies. If the coupling strength exceeds a certain threshold, the system can reach equilibrium, since the energy in the active tank can flow fast enough into the passive one to compensate its power dissipation. From FIG. 3A, we observe that at higher κ, the threshold of γ for the phase transition (γ_{EP}) can be reduced. As a result, a PT-symmetric telemetric sensor system, if designed properly to work in the exact PT-symmetric phase quantified by κ>κ_{PT}, can exhibit sharp and deep resonant reflection dips, ensuring high sensitivity with electrical noise immunity. From the circuit viewpoint, the reflectionless property in the one-port measurement is due to impedance matching. In the exact PT-symmetric phase with real eigenfrequencies, the input impedance looking into the active reader can be matched to the generator impedance Z₀ at the eigenfrequencies (or resonance frequencies), leading to the dips observed in the reflection spectrum.

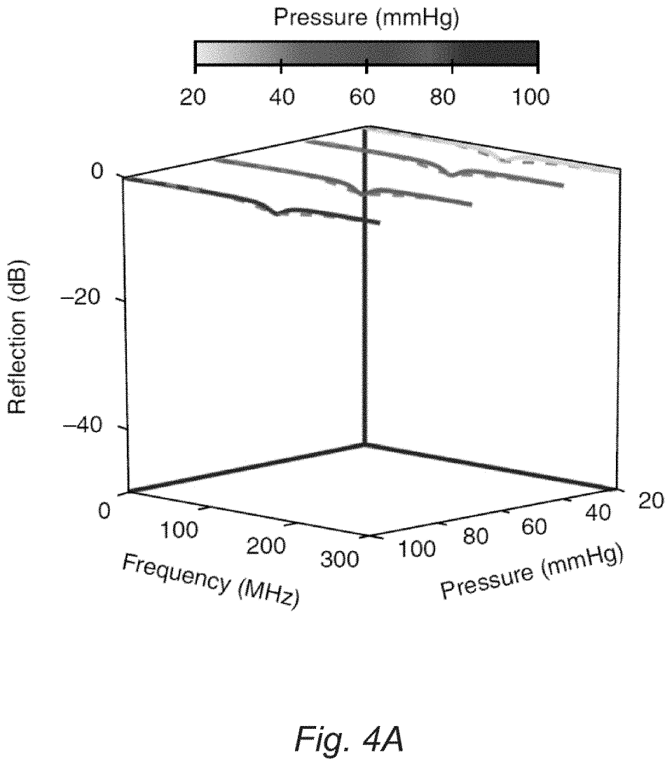

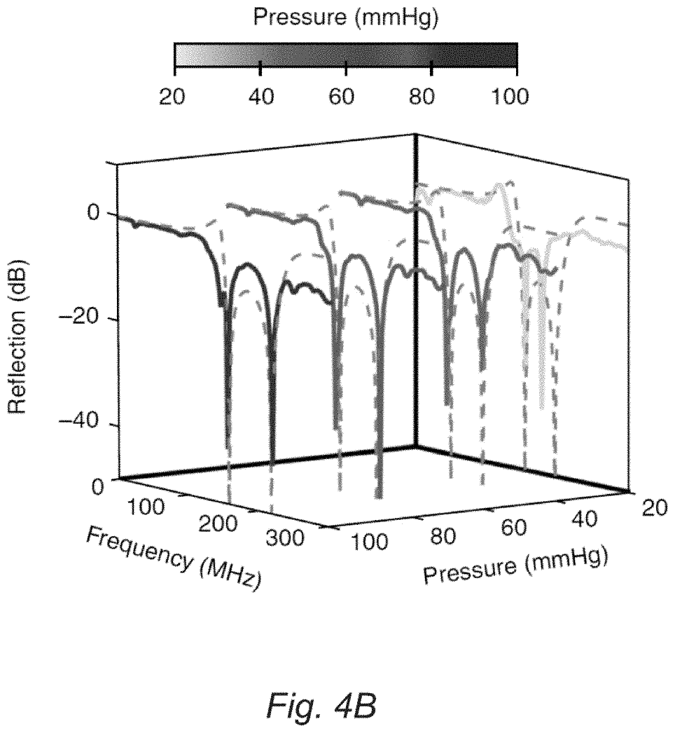

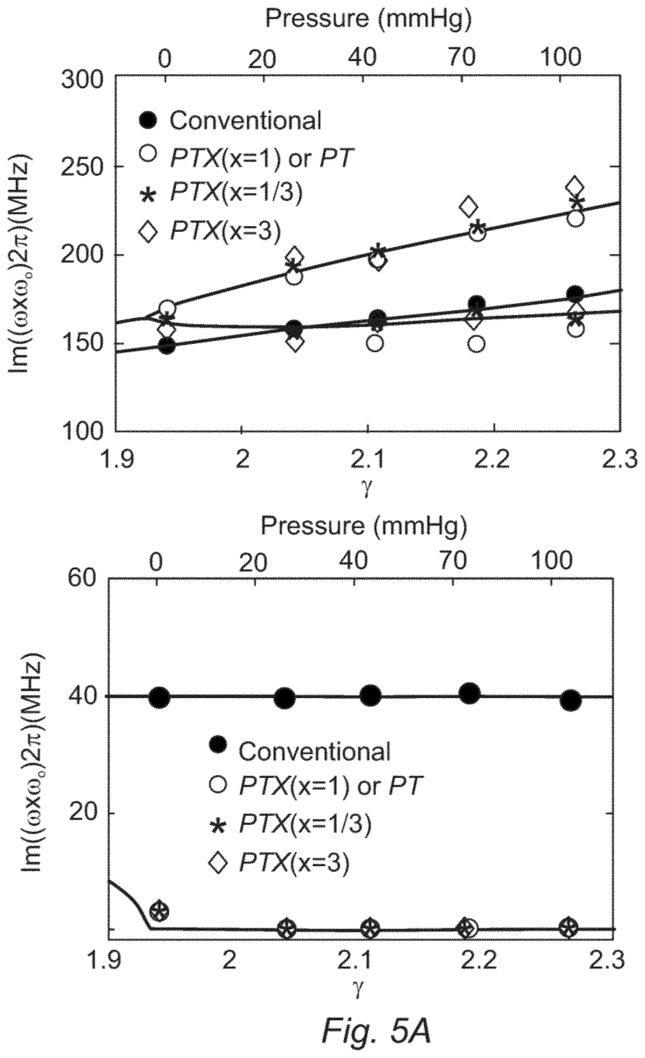

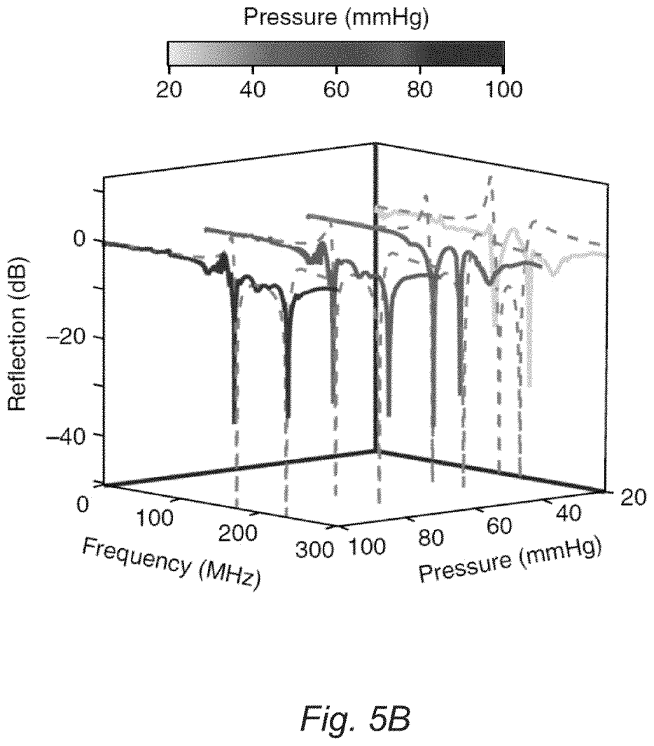

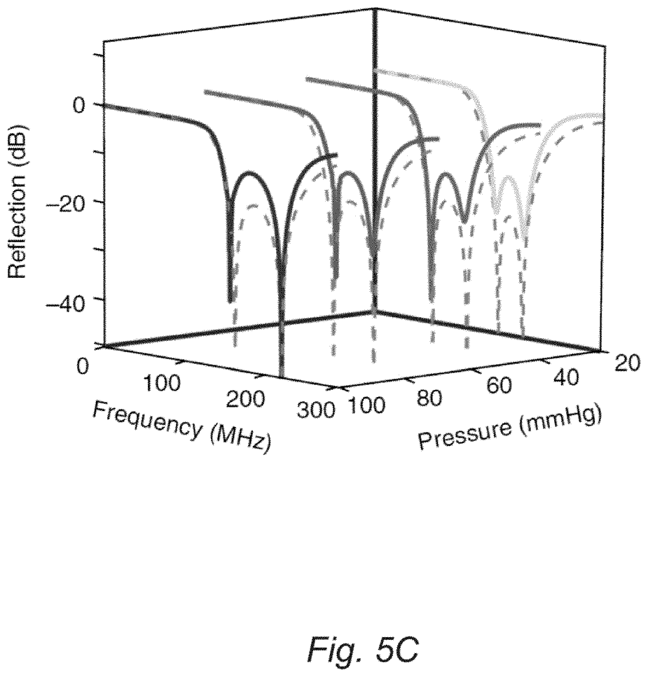

We also note that the splitting of the Riemann surface outlined in FIG. 3A may lead to an interesting topological response, implying a dramatic shift of the resonance frequency when γ is altered by pressure-induced capacitance changes in the microsensor (γ∝C⁻¹). It is interesting to compare these results with those obtained with a conventional fully passive telemetric sensing scheme (FIG. 3B)⁴⁻⁹, where the negative-resistance converter and varactors are removed from the active reader, leaving a coil antenna to interrogate the same pressure sensor. In this case, the eigenfrequency of the conventional passive system is always complex (FIG. 3B), no matter how γ and κ are varied, as expected for a lossy resonator, and the eigenfrequency surface is rather flat for both real and imaginary parts when compared with the PT-symmetric system (FIG. 3A). FIG. 4A,B presents the evolution of the reflection spectra for the two sensing systems; here, κ is fixed to 0.5 and γ is varied by changing the applied pressure (20, 40, 70 and 100 mmHg). The bifurcation of eigenfrequency in the PT-symmetric system (FIG. 4B) leads to the formation of two eigenmodes with sharp reflection dips, whose spectral shifts in response to γ can be dramatic and coincides with the topological phase transition shown in FIG. 3A. On the other hand, the passive system (FIG. 4A) exhibits a broad resonance, associated with a low sensing resolution, and a less observable change in the resonance frequency. It is evident that a PT-symmetric telemetric sensor can provide largely superior sensitivity when compared with conventional passive ones⁴⁻⁹, as it achieves not only a finer spectral resolution in light of a higher Q-factor, but also more sensitive frequency responses (FIG. 5A).

Next, we explore the functionality of the PTX-symmetric sensor within the same telemetry platform. Unlike the PT-symmetric system, the reciprocal scaling in the PTX system breaks the mirror symmetry of the effective |±R|, L and C; namely, their values in the sensor and the reader can be quite different for large or small values of x. In our experiments, the same MEMS-based pressure sensor was now paired with a new type of reader (FIG. 1B), whose equivalent circuit is similar to the reader used in FIG. 4B, but with all elements scaled following the rule: −R→−xR, L→xL, and C→x⁻¹C. This realizes a PTX-symmetric telemetry system that has a non-Hermitian Hamiltonian H (equation (1)) commuting with PTX (equation (2)). We have tested different values of x to investigate its effect on eigenfrequencies; here, κ was fixed to 0.5 in different set-ups. FIG. 5A shows the real and imaginary parts of eigenfrequencies against γ for PTX-symmetric telemetric sensor systems with x=3, ⅓ and 1. We note that x=1 corresponds to the PT-symmetric system discussed before.

We observe that a non-Hermitian PTX-symmetric Hamiltonian also supports real eigenfrequencies in the exact PTX-symmetric phase, thus leading to sharp and deep resonant reflection dips. As discussed earlier, in spite of the introduction of the X operator, the PTX-symmetric system and its PT-symmetric counterpart possess exactly the same eigenspectrum and bifurcation points, as clearly seen in FIG. 5A. In the PTX system, there is also a clear transition between the exact PTX-symmetric phase ( [symbol] XΨ=Ψ) and the broken PTX-symmetric phase ( [symbol] XΨ≠Ψ), which are respectively characterized by real and complex eigenfrequencies. The theoretical and experimental results in FIG. 5A imply that the spectral shift of resonance associated with the exceptional-point singularity in a PT-symmetric sensor can be likewise obtained in a PTX-symmetric sensor, as the same eigenspectrum is shared. We note that the PT and PTX systems, although sharing the same eigenspectrum, can have different eigenmodes; that is, Ψ=S⁻¹Ψ′ and S is correlated with x. FIG. 5B presents reflection spectra for the PTX-symmetric telemetric sensor with x=3, under different applied pressures. Due to the scaling operation X in the PTX-symmetric system, it is possible to further reduce the linewidth of the reflection dip and achieve a finer sensing resolution by increasing the value of x. In contrast to the case x>1, x<1 results in broadening of the resonance linewidth and thus a lowered Q-factor. We note that the input impedance (looking into the active reader) of PT- and PTX-symmetric telemetry systems can be identical and matched to the generator impedance Z₀ at their shared resonance frequencies, corresponding to reflectionless points (see below). As the frequency is away from the resonance frequency, the input impedance and reflection coefficient of PT- and PTX-symmetric systems may be very different, leading to a different resonance linewidth as a function of x. As a result, the PTX-symmetric telemetric sensor system (FIG. 5B), when compared with the PT-symmetric one (FIG. 4B), not only offers more design flexibility by removing certain physical constraints (for example, mirror-symmetric |±R|, L and C in the mutually coupled circuit), but also could support greater resolution, sensitivity and potentially longer interrogation distance enabled by the optimally designed self and mutual inductances of coils. Most importantly, both systems exhibit the same eigenspectrum and exceptional point. Ideally, in the exact PTX-symmetry phase, there is no fundamental limit to the Q-factor enhancement. In the extreme case when x approaches infinity, the resonance linewidth becomes infinitesimally narrow, namely the Q-factor is close to infinity, provided that such a reader circuit can be realized. However, in reality, the −R, L and C values of electronic devices have their own limits.

For generality, a microsensor (negative-resistance converter) can in principle be decomposed into a series or parallel equivalent RLC (-RLC) tank, and either choice is formally arbitrary, depending on the sensor and circuit architectures and on the kind of excitation (that is, impressed voltage or current source). The concept of PTX-symmetry can also be generalized to an electronic dimer utilizing the parallel circuit configuration, whose PT-symmetric counterpart has been demonstrated^{25,26}. It may also be possible to enhance the performance and resolution of a wireless resonant sensor modelled by a parallel RLC tank if the sensor is interrogated by a parallel -RLC tank^{25,26}, to satisfy the PTX-symmetry condition (see below for an example of the PTX-symmetric parallel circuit).

It should be noted that, in the exact symmetry phase of the PTX-symmetric system, although the gain and loss parameters (−xR and R) are not equal, the net power gained in the active tank and the one dissipated in the passive tank are balanced, similar to the PT-symmetric case. In the closed-loop analysis, the power loss in the passive tank Pₗₒₛₛ=|\dot{q}₂=²R/2, while the power gained in the active tank P_{gain}=|\dot{q}₁|²(xR−Z₀)/2+|\dot{q}₁|²Z₀, (where the first term accounts for power gained from the negative-resistance device and the second term corresponds to the external energy source modelled as a negative resistance −Z₀). Since the PTX-symmetry enforces the condition \dot{q}₁=\dot{q}₂/\sqrt{x}, gain and dissipation are always balanced in this system (that is, P_{gain}=Pₗₒₛₛ), regardless of the value of x. Therefore, although this generalized PT-symmetric system allows for arbitrary scaling of the gain and loss parameters (−R and R here), the gain-loss power balance is maintained in the exact symmetry condition, as expected by the fact that the eigenvalues are real. However, greater design flexibility on the linewidth of the response could be enabled.

Finally, it is interesting to note that in the PTX-symmetric system, if x is sufficiently small such that xR−Z₀≤0, both the reader and sensor circuits can be fully passive; namely, an inductively coupled RLC/RLC dimer is used. Such an observation is in stark contrast with what one would expect in conventional PT-symmetric systems, where pertinent gain or amplification is necessary to enable the associated peculiar phenomena. FIG. 5C presents reflection spectra for the PTX-symmetric telemetric sensor system with x=⅓; in this case, the reader is also a passive RLC tank without the need of a negative-resistance or amplification device. We observe a broad resonance, as the linewidth of the reflection dip is widened by decreasing the value of x. This operating regime (x=⅓), although not necessarily of interest for enhanced sensing capabilities, provides an interesting platform to study the dynamics of exceptional points and non-Hermitian physics in a loss-loss dimer, without the need for any active component. The presented PTX-symmetric dimer structure may also be extended to other frequencies, including light and ultrasonic waves. For instance, one potential application of our proposed reciprocally scaling operation is to provide an additional knob to tailor the threshold gain of PT-symmetric single-mode lasers¹⁸⁻²⁰ or coherent perfect absorber-lasers^{16,17} by breaking the exact balance of gain and loss coefficients, while preserving the spectrum of eigenvalues.

We have applied PT-symmetry and the generalized PTX-symmetry introduced here to RF sensor telemetry, with a particular focus on compact wireless micro-mechatronic sensors and actuators. Our approach overcomes the long-standing challenge of implementing a miniature wireless microsensor with high spectral resolution and high sensitivity, and opens opportunities to develop loss-immune high-performance sensors, due to gain-loss interactions via inductive coupling and eigenfrequency bifurcation resulting from the PT(PTX)-symmetry. Our findings also provide alternative schemes and techniques to reverse the effects of loss and enhance the Q-factor of various RF systems. Through our study of PTX-symmetry, we have shown that even asymmetric profiles of gain and loss coefficients can yield exotic non-Hermitian physics observed in PT-symmetric structures. Importantly, compared to PT-symmetry, PTX-symmetry offers greater design flexibility in manipulating resonance linewidths and Q-factors, while exhibiting eigenfrequencies identical to the associated PT-symmetric system.

Methods

Exceptional Point and Phase Transitions.

Applying Kirchhoff's laws to the PTX-symmetric circuit in FIG. 1B leads to the following set of equations:

$$\begin{matrix}\frac{{d}^{2} {q}_{1}}{d {τ}^{2}} = \frac{1}{1 - {κ}^{2}} {q}_{1} + \frac{1}{\sqrt{x}} \frac{κ}{1 - {κ}^{2}} {q}_{2} + \frac{1}{γ ( 1 - {κ}^{2} )} {\dot{q}}_{1} + \frac{1}{\sqrt{x}} \frac{κ}{γ ( 1 - {κ}^{2} )} {\dot{q}}_{2} & ( 3 a ) \\ \frac{{d}^{2} {q}_{2}}{d {τ}^{2}} = \sqrt{x} \frac{κ}{1 - {κ}^{2}} {q}_{1} - \frac{1}{1 - {κ}^{2}} {q}_{2} - \sqrt{x} \frac{κ}{γ ( 1 - {κ}^{2} )} {\dot{q}}_{1} - \frac{1}{γ ( 1 - {κ}^{2} )} {\dot{q}}_{2} & ( 3 b )\end{matrix}$$

which leads to the Liouvillian formalism in equation (1). After the substitution of time-harmonic charge distributions qₙ=Aₙe^{iωτ}, eigenfrequencies and normal modes for this PTX-symmetric electronic circuit can be computed from the eigenvalue equation (H−ωₖI)Ψₖ, with k=1, 2, 3, 4. The eigenfrequencies associated with the non-Hermiticity parameter γ and coupling strength κ can be derived as:

$${ω}_{1 , 2 , 3 , 4} = \pm \sqrt{\frac{2 {γ}^{2} - 1 \pm \sqrt{1 - 4 {γ}^{2} + 4 {γ}^{4} {κ}^{2}}}{2 {γ}^{2} ( 1 - {κ}^{2} )}} \qquad ( 4 )$$

There is a redundancy in equation (4) because positive and negative eigenfrequencies of equal magnitude are essentially identical. Equation (4) is also valid for the PT-symmetric system, as the eigenfrequencies in equation (4) are found to be independent of x. We note that if x=1, the PTX-symmetric system would degenerate into the PT one. The eigenmodes of the PT-symmetric system (Ψ′ₖ) and the PTX-symmetric system (Ψₖ) can be written as:

$$\begin{matrix}{Ψ}_{k}^{′} = {{c}_{k} ( {e}^{- i {φ′}_{k}} , {e}^{i φ′k} , - i {ω}_{k} {e}^{- i {φ′}_{k}} , - i {ω}_{k} {e}^{i {φ′}_{k}} )}^{T} , {c}_{k} ∈ ℝ & ( 5 a ) \\ {e}^{2 i {φ′}_{k}} = \frac{γ [ ( 1 - {κ}^{2} ) {ω}_{k}^{2} - 1 ] + i {ω}_{k}}{κ ( γ + i {ω}_{k} )} & ( 5 b ) \\ {Ψ}_{k} = {S}^{- 1} {Ψ}_{k}^{′} & ( 5 c )\end{matrix}$$

Complex eigenfrequencies would evolve with γ, unveiling three distinct regimes of behaviour. The eigenfrequencies undergo a bifurcation process and branch out into the complex plane at the exceptional point (or spontaneous PTX-symmetry breaking point):

$${γ}_{EP} = \frac{1}{κ} \sqrt{\frac{1 + \sqrt{1 - {κ}^{2}}}{2}} \qquad ( 6 )$$

In the parametric region of interest γ∈[γ_{EP}, ∞], PTX-symmetry is exact, rendering real eigenfrequencies and [symbol] XΨₖ=Ψₖ. The region γ∈[γ_{c}, γ_{EP},], is known as the broken PTX-symmetric phase with complex eigenfrequencies. Another crossing between the pairs of degenerate frequencies (and another branching) occurs at the lower critical point:

$${γ}_{c} = \frac{1}{κ} \sqrt{\frac{1 - \sqrt{1 - {κ}^{2}}}{2}} \qquad ( 7 )$$

In the sub-critical region γ∈[0, γ_{c}], ωₖ, become purely imaginary and, therefore, the modes have no oscillatory part and simply blow up or decay away exponentially. These modes correspond to the overdamped modes of a single oscillator, which is of little interest, particularly for sensor applications that require sharp resonances.

Wireless Measurement Set-Ups.

Our experimental set-up comprised a MEMS-based wireless pressure sensor, inductively coupled to a conventional passive reader or an active reader. The MEMS varactor is constituted by two circular parallel metal sheets with a diameter of 4 mm and an air gap of 100 μm. To simulate variations of internal pressure inside the human eye, the sensor, placed on an XYZ linear translation stage, was encapsulated with epoxy polyamides and connected with an air compressor. A microprocessor-controlled regulator (SMC E/P Regulator) was used to control the internal pressure inside the air cavity of the MEMS varactor. The active reader composed of an -RLC tank was fixed and connected to a VNA (Agilent E5061B). This allows for precise control of the coupling strength κ between the MEMS-based pressure sensor and the reader coil. The internal pressure inside the micromachined air cavity of the sensor, as the main physiological parameter of interest, was characterized by tracking the resonance frequency from the measured reflection coefficients. In our experiments, the pressure was varied from 0 mmHg to 200 mmHg, and the VNA and the pressure regulator were synchronously controlled by the LabVIEW program.

Design and Characterization of MEMS-Based Pressure Sensor

Design of MEMS-Actuated Capacitive Pressure Sensor

A typical passive pressure sensor contains an LC resonator, including a pressure-tuned parallel-plate capacitor and a planar micro-coil inductor. Such device architecture has been widely adopted for pressure sensors in many medical, industrial, automotive, defense and consumer applications. Assuming no fringe effect, the capacitance is given by:

$$C = {ɛ}_{0} {ɛ}_{r} \frac{A}{d} \qquad ( 8 )$$

where εᵣ is the relative permittivity, ε₀ is free space permittivity, A and d are the area of two capacitor electrodes and the separation distance between them (when no pressure is applied). As schematically shown in FIG. 2 in the main text, the MEMS varactor includes a movable upper electrode and a stationary lower electrode, which are separated by a variable air gap (εᵣ=1). The lower electrode is fixed to the substrate and has a small drain hole connected to the compressor through a sealed tube. Therefore, the pressure inside the encapsulated air cavity can be controlled by a pressure regulator. As the internal pressure increases, the upper electrode is gradually bent upward such that the total capacitance of the MEMS varactor is varied. The maximum displacement of the movable upper electrode Δd, as a function of pressure P and electrode's material parameters (Young's modulus E and Poison ratio ν), can be calculated using the Euler-Bernoulli theory (see, Li, C., et al. “A high-performance LC wireless passive pressure sensor fabricated using low temperature co-fired ceramic (LTCC) technology.” Sensors, vol. 14, 23337-23347, 2014), leading to:

$$Δ d = \frac{3 {Pa}_{0}^{4} ( 1 - {v}^{2} )}{16 {Et}^{3}} \frac{1}{1 + 0.448 {( \frac{d}{t} )}^{2}} \qquad ( 9 )$$

where a₀ and t represent the radius and thickness of the circular metallic plates. Consider the pressure-driven displacement, the capacitance can be calculated by conducting the surface integral over the metallic disk:

$${C}^{′} = 2 {πɛ}_{0} {ɛ}_{r} {\int }_{0}^{{a}_{0}} \frac{r}{d + δ d ( r )} dr \qquad ( 10 )$$

where d(r) is the function of deflection depending on the radial position of the membrane. Under an internal pressure, C′ can be approximately expressed as a function of Δd:

$${C}^{′} = C \frac{\sqrt{\frac{Δ d}{d}}}{{tanh}^{- 1} \sqrt{\frac{Δd}{d}}} \qquad ( 11 )$$

For most commonly used copper electrodes, important material parameters are: E=117 GPa and ν=0.33. In our design, the two copper disks have the same radius a₀=2 mm initially separated by an air gap d=100

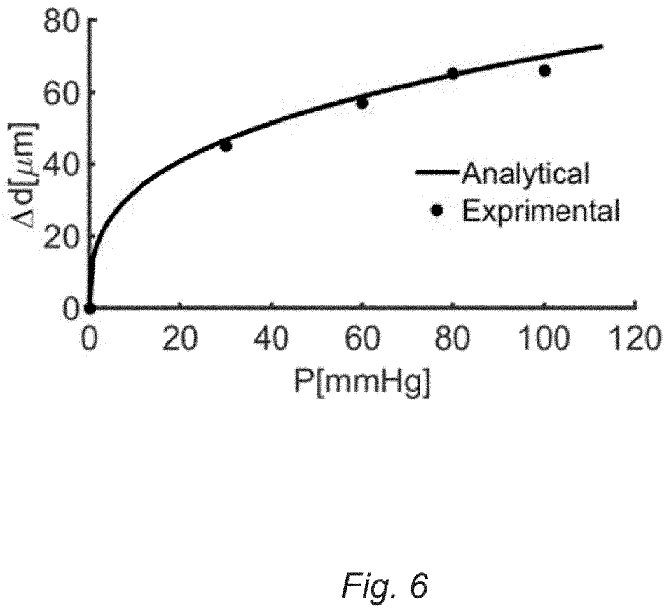

FIG. 6 shows the theoretical and measurement results for the maximum displacement of the movable upper electrode as a function of the applied pressure. The scanning white-light interferometry (SWLI) was used to determine the maximum displacement. It is seen from FIG. 6 that the experimental results agree with the theory quite well, confirming the validity of Eq. (7). As can be expected, the displacement of upper electrode increases with increasing the applied pressure, which, in turn, reduces the total capacitance.

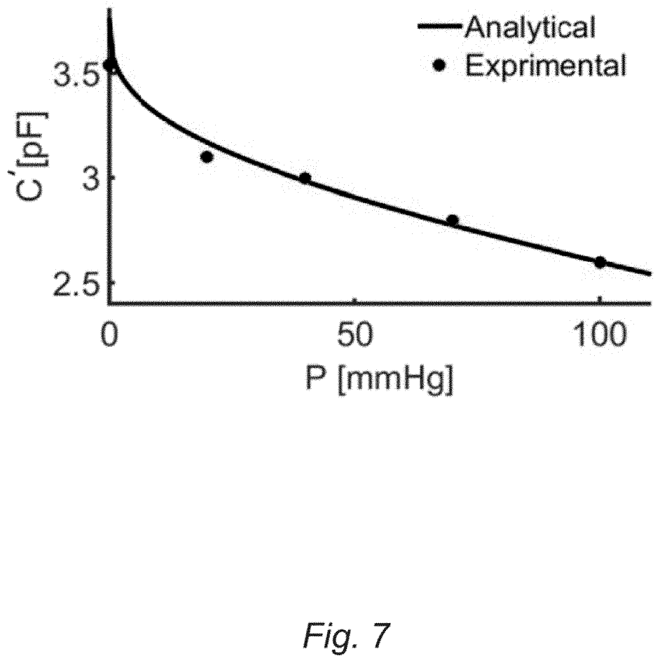

To character the practical capacitance and the effective resistance of the sensor, we first used an external coil to contactlessly read the sensor, and then analyzed the reflection responses to retrieve lumped-element parameters in the equivalent circuit. In our characterizations, we first characterized an individual micro-coil (without loading the capacitor) for knowing its inductance value, as well as the mutual inductance between two tightly coupled micro-coils. Once the impedance of the micro-coil is known, the capacitance of the complete sensor as a function of applied pressure can be retrieved by fitting experiment data with the equivalent circuit model. From the complex reflection coefficient, the effective resistance of the sensor can also be retrieved, which is found to be almost invariant under different pressures (˜150Ω). FIG. 7 presents theoretical and experimental values of capacitance of the MEMS varactor; here capacitance as a function of pressure was calculated using Eqs. (9)-(11). The experimental and theoretical results exhibit good agreement, despite slight differences due to fringing effects and microfabrication imperfections. It is seen from FIG. 7 that the sensor's capacitance decreases with increasing the applied pressure, due to the enlarged air gap Δd (FIG. 6).

Design of Microcoil Inductor

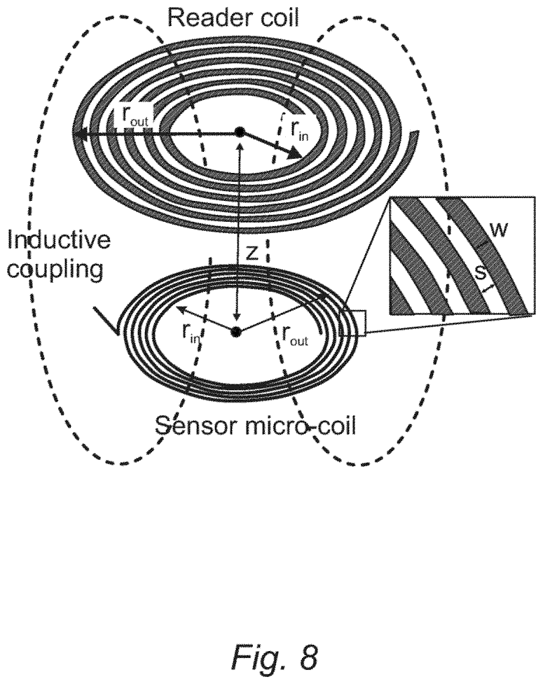

The self-inductance of the planar micro-coil inductor in FIG. 8 can be derived from the ratio between the magnetic flux and current, which has an approximate expression n as (see, Lee, T. H., Planar microwave engineering: a practical guide to theory, measurement, and circuits, Cambridge University Press, Cambridge, United Kingdom, 2004):

$$L = \frac{{μ}_{0} {N}^{2} {d}_{avg}}{2} [ ln ( \frac{2.46}{ϕ} ) + 0.2 {ϕ}^{2} ] , \qquad ( 12 )$$

where μ₀ is the free space permeability, N is number of turns, d_{avg}=2rᵢₙ+N×(s+w) is the average diameter of spiral coil, 2rin is inner diameter of spiral coil, w and s are width and spacing of the coil, and φ=N×(s+w)/[dᵢ+N×(s+w)] is the filling ratio. We have applied Eq. (12) to design the reader/sensor micro-coils. For example, the inductance values and important design parameters for micro-coils used in the PT-symmetric sensor (FIG. 4B) are summarized in Table 1.

TABLE 1
Physical parameters for TOP sensor and reader.

| | L [μH] | N | s [mm] | w [mm] | rᵢₙ [mm] |
|---|---|---|---|---|---|
| Sensor | 0.3 | 5.5 | 0.075 | 0.075 | 2.4 |
| Reader | 0.28 | 6 | 0.25 | 0.25 | 2 |

The mutual inductance for two filamentary currents i and j can be computed using the double integral Neumann formula (see, Raju, S., Wu, R., Chan, M., and Yue, C. P., “Modeling of mutual coupling between planar inductors in wireless power applications.” IEEE Trans. Power Electron., vol. 29, 481-490, 2014):

$${M}_{ij} = \frac{{μ}_{0}}{4 π} {\int }_{{C}_{i}} {\int }_{{C}_{j}} \frac{1}{\vert {R}_{ij} \vert} d {\vec{l}}_{i} \cdot d {\vec{l}}_{j} , \qquad ( 13 )$$

where Rᵢⱼ represents the distance between metallic lines, which has a relation with the radius of each coil and the central distance between them. The calculation of total mutual inductance for coils with multiple turns is possible with the summation of the separate mutual inductance of each current filament:

M=ρΣᵢ₌₁^{N}^{_{R}}Σⱼ₌₁^{N}^{_{S}}Mᵢⱼ, (14)

where i (j) represents the i-th (j-th) turn of micro-coil on the reader (sensor) side, ρ is the shape factor of planar coil (see, Raju et al. ibid.), and Mᵢⱼ is the mutual inductance between the loops i and j, which are given by:

$${M}_{ij} \approx \frac{{μ}_{0} π {a}_{i}^{2} {b}_{j}^{2}}{2 {( {a}_{i}^{2} + {b}_{j}^{2} + {z}^{2} )}^{3 / 2}} \qquad ( 15 )$$

where z is the central distance between two micro-coils, aᵢ=r_{o,R}−(Nᵢ−1) (w_{R}+S_{R})−w_{R}/2, bᵢ=r_{o,R}−(Nᵢ−1)(w_{R}+S_{R})−w_{S}/2, Nᵢ(Nⱼ) represents the i-th (j-th) turn of reader (sensor) coil, rₒ is the outer radius of the microcoil, and the subscript R (S) represents reader (sensor). Finally, the coupling coefficient between the reader and sensor micro-coils is given by κ=M/\sqrt{L_{R}L_{S}}, where L_{R} is the reader coil inductance and L_{S} is the sensor coil inductance. In our designs, we first characterized the self-inductance of each individual coil using the analytical formula of Eq. (5), which has been verified with the full-wave simulation. Then, the total mutual inductance between two micro-coils was calculated using the analytical formula of Eqs. (14)-(15) and the result was confirmed by the full wave simulations. In our designs, the coupling coefficient K is in the range 0 to 0.5.

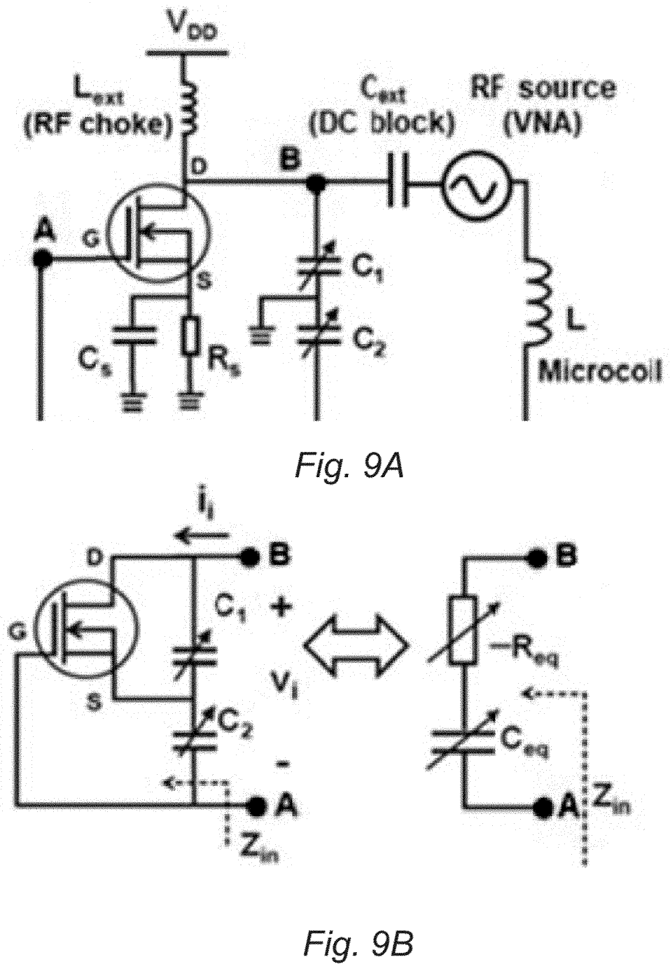

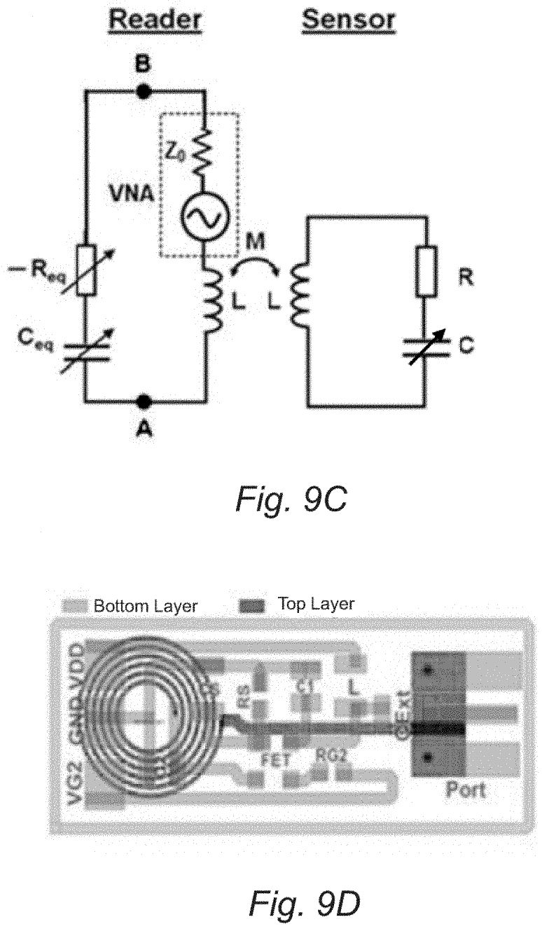

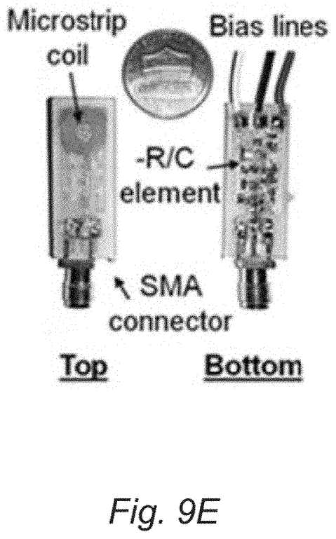

To build the PT-/PTX-symmetric electronic circuit, it requires a negative resistor (−R), realized using a negative resistance converter (NRC) at high frequencies. An active NRC could pull in power to the circuit, rather than dissipating it like a passive resistor. FIG. 9A shows the circuit diagram of our NRC, inspired by the design of Colpitts-type oscillator. This NRC as an active lumped resistor may provide stable and almost non-dispersive negative resistance over a broad frequency range. The negative resistance can be a series or a parallel element, depending on how the circuit is designed, i.e., a series (parallel) circuit model is usually used for voltage-controlled negative resistance oscillators (current-controlled negative conductance oscillators) (see, Pozar, D. M., Microwave engineering, John Wiley & Sons, 2009). For example, in Schindler et al., a one-port op-amp inverting circuit operating at KHz frequencies, equivalent to a parallel negative resistance, was used to demonstrate a PT-symmetric system based on parallel -RLC and RLC tanks. (Schindler, J., et al. PT-symmetric electronics; J. Phys. A: Math. Theor. vol. 45, 444029, 2012). In the circuit analysis, it is common to model the Colpitts- or Hartley-type oscillator with positive feedback as a negative resistor (−R). One method of oscillator analysis is to determine its input impedance, neglecting any external reactive component at the input port, as shown in FIG. 9B. For the Colpitts circuit configuration in FIG. 9B, the complex input impedance (Zin=vᵢ/iᵢ) looking into the points A and B can be derived as:

$${Z}_{in ( AB )} = - \frac{{g}_{m}}{{ω}^{2} {C}_{1} {C}_{2}} + i ( \frac{1}{ω {C}_{1}} + \frac{1}{ω {C}_{2}} ) \qquad ( 16 )$$

where gₘ is the transconductance of the field-effect transistor (FET); here we assume that the gₘ>>ωC_{gd}, and ωC_{gs} (C_{gd} and C_{gs} are the gate-drain capacitance and gate-source capacitances), which is approximately valid at moderately low frequencies (e.g., VHF band in this paper). As a result, the input impedance looking into the points A and B is equivalent to a series −RC circuit consisting of a negative resistance −R_{eq} and an equivalent capacitance C_{eq}, as shown in in FIG. 9B: which is approximately valid at moderately low frequencies (e.g., VHF band in this paper). As a result, the input impedance looking into the points A and B is equivalent to a series −RC circuit consisting of a negative resistance in FIG. 9B:

$$- {R}_{eq} = - \frac{{g}_{m} ( {V}_{bias} )}{{ω}^{2} {C}_{1} {C}_{2}} and {C}_{eq} = \frac{{C}_{1} {C}_{2}}{{C}_{1} + {C}_{2}} \qquad ( 17 )$$

By connecting the input port to an inductor, a positive feedback oscillator can be made by controlling the open-loop and feedback gains at the resonance frequency. As known form Eq. (17), the negative resistance can be increased by using larger values of transconductance and smaller values of capacitance. If the two capacitors are replaced by inductors, the circuit becomes a Hartley oscillator, whose input impedance becomes the −RL combination.

According to Eqs. (16) and (17), the effective resistance is controlled by the transistor's transconductance, readily adjusted by DC offset voltages. The RF transistors used here have high cutoff frequencies up to several GHz, ensuring the minimum parasitic effects and the stability of circuit. The effective capacitance is determined by the two lumped capacitances C₁ and C₂ which could be contributed by the voltage-controlled varactors such that the effective capacitance of the -RLC tank is tunable. If a micro-coil inductor is connected to the input of the Colpitts oscillator (points A and B in in FIGS. 9B and 9C), a series -RLC tank can be realized if that the AC source is connected in series to the inductor, as can be seen in FIG. 9C. FIGS. 9D and 9E show the circuit layout and the fabricated printed circuit board (PCB) for the active reader used in PT-symmetric system (in FIG. 9B), respectively. This active reader consists of the voltage-tuned NRC (FIG. 9A), which are connected in series to a planar coil, forming the -RLC tank.

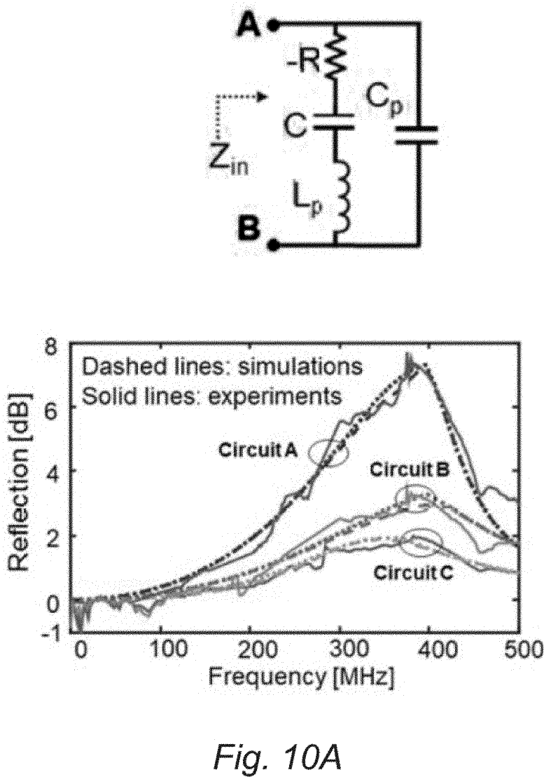

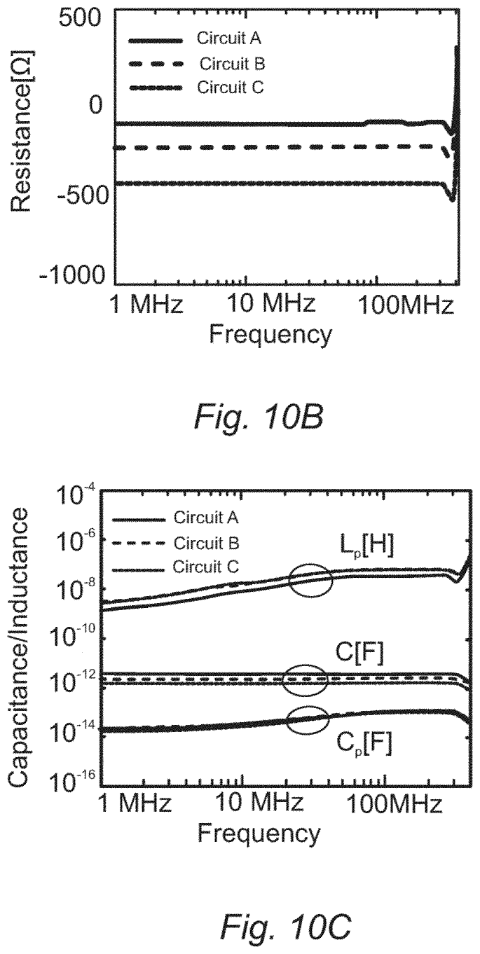

The effective impedance of the NRC can be retrieved from the measured reflection coefficient of an isolated series -RLC tank connected to the vector network analyzer (VNA), by decomposing the contribution of the coil inductance. An individual -RLC tank can allow the reflected RF signal to have larger amplitude than the incident one, namely the steady-state reflection gain is achieved. However, in experiments the reflection cannot be infinitely large because all transistors and electronic components have maximum operating voltage/current ranges, large-signal effects, and inherent nonlinearities. In a similar sense, although in theory a pole could arise in a -RLC tank, an ever-growing eigenmode (charge/charge flow) is never achieved due to the above-mentioned nonlinear effects in real-world electronic devices. A more detailed equivalent circuit of the Colpitts-type NRC is shown in FIG. 10A, which includes also a shunt inductance Lp and a parasitic capacitance Cp. We note that, sufficiently low frequencies, Cp has a high RF impedance Zc=i/ωCp (acting like a low-pass filter or an open circuit), while Lp has a low RF impedance Zₗ=−iωLp (acting like a short circuit). Therefore, the parasitic effect may be minimized if the operating frequency is moderately low, well below the transistor's cutoff frequency (f_{T}) and maximum frequency (fₘₐₓ). FIG. 10A presents the experimental (solid) and simulated (dashed) reflection spectra of the Colpitts-NRC shown in FIG. 9, under different simulations, the equivalent resistive and reactive values in the DC bias conditions. In our circuit model, as shown in FIGS. 10B and 10C, were extracted from the measured reflection coefficients by using the numerical optimization. From FIG. 10A, a good agreement is found between the experimental and simulation results. Here, we also present the reflection spectra for the equivalent circuit in FIG. 10A without the parasitic capacitance (dotted). The results show no significant difference in the frequency range of interest, when compared to those obtained from experiments and the full equivalent circuit model.

As a result, for our initial analysis, parasitic elements and device nonlinearities are ignored. In the frequency range of interest, the experimentally measured input impedance can be decomposed into a series combination of a negative resistance and a capacitance. This simplified model shows an acceptable comparison with experimental results, as can be seen in FIG. 10A. It is clearly seen from FIG. 10B that that negative resistance can be tuned by adjusting the DC offset voltage and their values are nearly invariant at low frequencies.

Microfabrication and Characterization of the Wireless Pressure Sensor

Fabrication of Wireless Pressure Sensors by the MEMS Processes

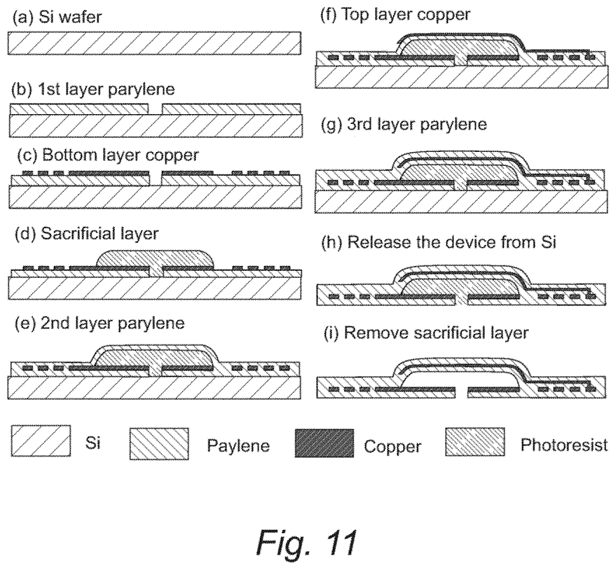

FIG. 11 presents the fabrication flow of the MEMS-based intraocular pressure (TOP) sensor in FIG. 2. In step (a), the silicon (Si) wafer was first cleaned following the standard RCA cleaning process. In step (b), an 8 μm-thick parylene layer was deposited using the thermally activated chemical vapor deposition (CVD) method in the Specialty Coating Systems (SCS PDS 2010). In this parylene layer, the sensor's backside was etched to form a pressure access hole with diameter of 0.8 mm by using the oxygen reactive ion etching (RIE, DryTech RIE 184). In step (c), a 3 μm-thick copper (Cu) film was deposited using the electron beam evaporation (Temescal Model BJD-1800 e-beam evaporator). Standard photolithography was used to pattern the copper and form the coil inductor and the capacitor pad. In steps (d)-(e), a sacrificial photoresist layer was patterned by the lithographic method, following the coating of the second parylene layer that has a thickness of 4 μm. In step (f), the second Cu layer was deposited and patterned by the lithographic method; here the top and bottom metallic structures were connected by a Cu interconnect patterned by oxygen RIE. In step (g), the third parylene with a thickness of 8 μm was coated as protection layer. After that, the device was released from Si substrate using the KOH solution. In the last step, (h), the sacrificial layer was removed in acetone solution with the critical point dryer (CPD) (Tousimis 931). Finally, the microfabricated IOP sensor was made with a flexible air cavity that can be actuated by the internal pressure, as shown in (i).

Measurement Setup for the MEMS Wireless Pressure Sensors

The wireless measurement setup comprises a MEMS-based pressure sensor, inductively coupled to a passive or active reader (interrogator). The MEMS-based pressure sensor consists of a variable capacitor (varactor) functioning as a transducer, connected in series to a planar microcoil inductor. In the equivalent circuit diagram, the pressure sensor itself stands for a RLC tank, where the applied pressure mechanically deforms the MEMS varactor and therefore varies the sensor's natural frequency. The pressure sensor was encapsulated with epoxy polyamides and connected with an air compressor. A microprocessor-controlled regulator (SMC E/P Regulator) was used to control the internal pressure inside the air cavity of MEMS varactor. The sensor was fixed on a XYZ linear translation stage and the active reader composed of -RLC tank was connected to vector network analyzer (VNA: Agilent E5061B). This setup allows for precise control of the coupling strength between the MEMS sensor and the reader coil.

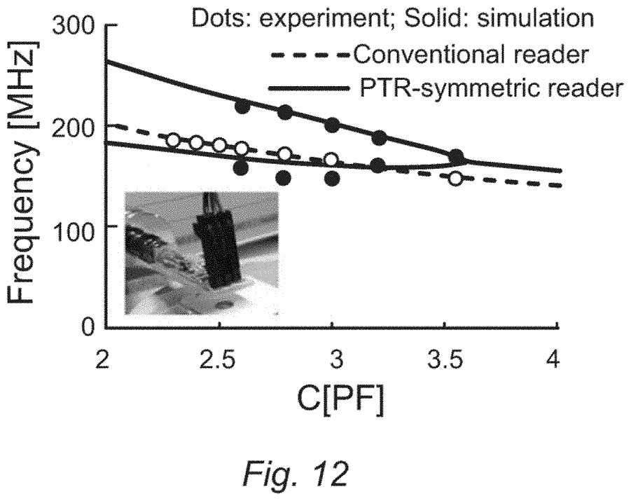

FIG. 12 shows the theoretical and experimental results for eigenfrequency variations of the PT-symmetric wireless pressure sensor system, where the capacitance of the microfabricated pressure sensor is changed with respect to the pressure-induced displacement; here an equivalent resistance of 150Ω was measured for the sensor, and the inductance of the sensor's micro-coil is about 300 nH. When the sensor's capacitance is varied (FIG. 7), the effective capacitance of the active reader should also be tuned accordingly to maintain the PT-symmetry. This can be achieved by precisely controlling the DC offset voltage of varactors in the reader circuit. To make a fair comparison, we also studied the conventional wireless pressure sensor system, where a passive external coil (the same as the one used in the active reader) was used to read the microsensor. As can be seen in FIG. 12, the PT-symmetric telemetric sensor system can provide a larger resonance frequency shift in response to pressure-driven capacitance variations. We note that a PTX-symmetric sensor would display the same sensitivity because the PT and PTX systems share the same eigenspectrum, as discussed in the above.

Analysis of PTX-Symmetric Electronic Systems

PTX-Symmetric Circuits in the Parallel Configuration

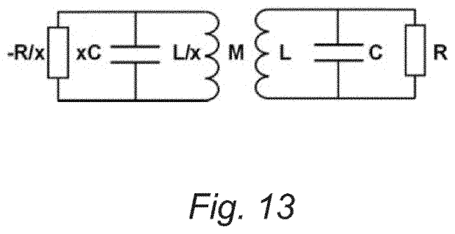

The passive LC wireless sensors are also commonly designed and modeled using an equivalent, parallel RLC circuit (excited by an impressed current source). We note that the concept of PTX-symmetry can in principle be applied to different types of series and parallel circuits, and possibly their complex combinations. FIG. 13 shows a PTX-symmetric circuit formed by the parallel -RLC and RLC tanks, which communicate through the inductive coupling. Such a system is invariant under the parity transformation [symbol] (q₁↔q₂), time-reversal transformation [symbol] (t↔−t), and reciprocal scaling X(q₁→x^{1/2}q₁), where q₁(q₂) corresponds to the charge stored in the capacitor in the parallel -RLC (RLC) tank. Its PT-symmetric counterpart with x=1 have been experimentally demonstrated in Schindler et al., in which a shunt negative resistor was realized using the op-amp inverting circuit. According to the Kirchoff s law, the Liouvillian L and the effective Hamiltonian H of the PTX-symmetric circuit in FIG. 13 can be derived as:

$$H = iL and L = ( \begin{matrix}0 & 0 & 1 & 0 \\ 0 & 0 & 0 & 1 \\ - \frac{1}{1 - {κ}^{2}} & \frac{1}{\sqrt{x}} \frac{κ}{1 - {κ}^{2}} & γ & 0 \\ \sqrt{x} \frac{κ}{1 - {κ}^{2}} & - \frac{1}{1 - {κ}^{2}} & 0 & - γ\end{matrix} ) \qquad ( 18 )$$

where ω₀=1/\sqrt{LC}, the coupling strength between the active and passive tanks κ=\sqrt{x}M/L, the non-Hermiticity parameter γ=R⁻¹\sqrt{L/C}=(|−R|/x)⁻¹\sqrt{(L/x)/(xC)}, and all frequencies are measured in units of ω₀. The effective Hamiltonian is non-Hermitian (i.e., H^{†}≠H) and commutes with [symbol] X; here [symbol] , [symbol] , and X are defined in Eq. (2) in the main text. The Hamiltonian and eigenmodes of this PTX system can be linked to those of its PT counterpart (H′, Ψ′) through the similarity transformation H=S⁻¹H′S and Ψ=S⁻¹Ψ′ where S is an invertible 4-by-4 matrix S=1⊗ζ and

$$ζ = ( \begin{matrix}{x}^{1 / 2} & 0 \\ 0 & 1\end{matrix} )$$

As a result, the PTX and PT systems share the same eigenfrequencies, given by:

$${ω}_{1 , 2 , 3 , 4} = \pm \sqrt{\frac{2 - {γ}^{2} ( 1 - {κ}^{2} ) \pm \sqrt{4 {κ}^{2} - 4 {γ}^{2} ( 1 - {κ}^{2} ) + {{γ}^{4} ( 1 - 4 {κ}^{2} )}^{2}}}{2 ( 1 - {κ}^{2} )}} \qquad ( 19 )$$

which is found to be independent of x. Such results are consistent with our previous findings on the series -RLC/RLC dimer satisfying the PTX-symmetry. The scaling coefficient x plays a role in controlling the linewidth of the resonance. Therefore, the PTX-symmetry concept can also be exploited to improve the Q-factor and sensitivity of a wireless resonant sensor based on a parallel RLC circuit model.

Reflectionless Property and Impedance Matching

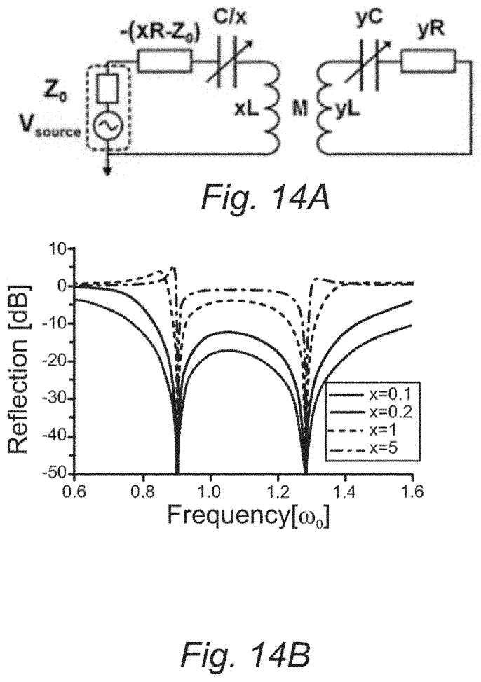

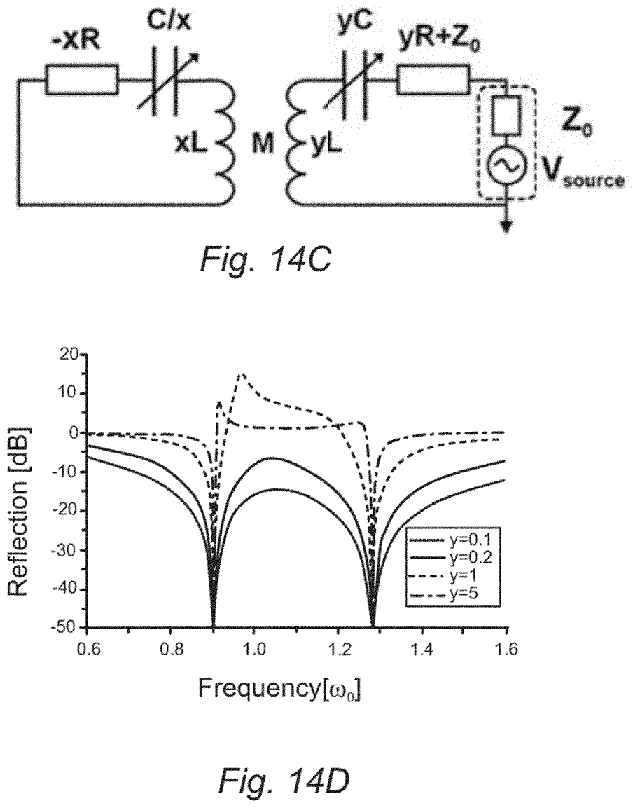

FIG. 14A considers a generalized PTX-symmetric circuit that is invariant under the PTX transformation. Here, X=1⊗x₀ and

$${x}_{0} = ( \begin{matrix}{( x \text{/} y )}^{1 / 2} & 0 \\ 0 & {( x \text{/} y )}^{- 1 / 2}\end{matrix} )$$

which yield q₁→(x/y)^{1/2}q₁ and q₂→(x/y)^{-1/2}q₂. In this case, both active and passive tanks have the same non-Hermiticity parameter as γ=x|−R⁻|\sqrt{(xL)/(C/x)}=(yR)⁻¹\sqrt{(yL)/(C/y)}. For this coupled circuit, the input impedance looking into the -RLC tank from the RF generator end can be derived as:

$${Z}_{m} = {Z}_{0} \frac{{ω}^{2} - i ωγ ( {ω}^{2} - 1 ) - x [ {ω}^{2} - {γ}^{2} ( 2 {ω}^{2} + {ω}^{4} ( {μ}^{2} - 1 ) - 1 ) ] / η}{{ω}^{2} - i ωγ ( {ω}^{2} - 1 )} \qquad ( 20 )$$

where ω is the angular frequency, the generator impedance Z₀=ηR [Ω] and η is the impedance normalization factor. In the single-port measurement, the information is encoded in the reflection coefficient at the input port, which can be written as:

Γ=(Zᵢₙ−Z₀)/(Zᵢₙ+Z₀) (21)

It is interesting to note that the input impedance and the reflection coefficient are independent of y used in the RLC tank. This could enable more flexibility in the sensor design when compared with the traditional PT-symmetric setup. The input impedance and reflection coefficient of the PT-symmetric telemetry system are obtained by setting x=1 in Eq. (20), (21). In the exact PT-/PTX-symmetric phase, the eigenfrequencies are real, corresponding to the dips in the reflection spectrum. From the RF circuit viewpoint, the reflectionless property is due to the perfect impedance matching, namely Zᵢₙ=Z₀ at the eigenfrequencies (resonance frequencies), leading to Γ=0.

FIG. 14B shows the reflection spectrum for the PTX-symmetric circuits in FIG. 14A, under different values of x; here γ=2.5, μ=2.5, η=0.2, and y is an arbitrary positive real number (because Zin and Γ are independent of y). The PT-symmetric system is obtained when x=y=1. It can be seen from FIG. 14B that for different PTX-symmetric systems, the reflection coefficient is always zero at the given eigenfrequencies, while the resonance linewidth can be tuned by varying the scaling coefficient x. Most importantly, the Q-factor, which is inversely proportional to the resonance bandwidth, increases with increasing the value of x, as has been demonstrated in our telemetry experiments (FIG. 5). As opposed to an active reader, a passive reader with x≤η can exhibit low reflection over a broad bandwidth, which could be of interest for applications that require large amounts of bandwidth, such as the high-speed communication.

FIG. 14C considers the second case, in which the RF input port is connected to the passive RLC tank (e.g., an active sensor interrogated by a passive reader). In this scenario, the input impedance can be derived as:

$${Z}_{in} = {Z}_{0} \frac{{ω}^{2} + i ωγ ( {ω}^{2} - 1 ) + y [ {ω}^{2} - {γ}^{2} ( 2 {ω}^{2} + {ω}^{4} ( {μ}^{2} - 1 ) - 1 ) ] / η}{{ω}^{2} + i ωγ ( {ω}^{2} - 1 )} \qquad ( 22 )$$

It is worth mentioning that in this case, the input impedance and the reflection coefficient are independent of x used in the active tank. According the coupled-mode analysis, the circuits in FIGS. 14A and 14C share the same eigenfrequencies. In the exact PTX-symmetric phase, applying the real eigenfrequencies to the input impedance in Eq. (22) results in Zᵢₙ=Z₀ and thus zero reflection can be obtained in these frequencies. FIG. 14D shows the reflection spectra for the PTX-symmetric circuits in FIG. 14C, under different values of y; here γ=2.5, μ=2.5, η=0.2, and x is an arbitrary positive real number (because Zin and Γ are independent of x). It is clearly seen that the zero reflection takes place at the same frequencies observed in FIG. 14B, and the resonance linewidth can be tuned by varying the value of y.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1. Nopper, R., Niekrawietz, R. & Reindl, L. Wireless readout of passive LC sensors. IEEE Trans. Instrum. Meas. 59, 2450-2457 (2010).
2. Collins, C. C. Miniature passive pressure transensor for implanting in the eye. IEEE Trans. Biomed. Eng. 2, 74-83 (1967).
3. Pozar, D. M. Microwave Engineering 4th edn (John Wiley & Sons, New York, 2012).
4. Mokwa, W. Medical implants based on microsystems. Meas. Sci. Technol. 18, R47-R57 (2007).
5. Chavan, A. V. & Wise, K. D. Batch-processed vacuum-sealed capacitive pressure sensors. J. Micro. Syst. 10, 580-588 (2001).
6. Chen, P. J., Rodger, D. C., Saati, S., Humayun, M. S. & Tai, Y. C. Microfabricated implantable parylene-based wireless passive intraocular pressure sensors. J. Micro. Syst. 17, 1342-1351 (2008).
7. Chen, L. Y. et al. Continuous wireless pressure monitoring and mapping with ultra-small passive sensors for health monitoring and critical care. Nat. Commun. 5, 5028 (2014).
8. Huang, H., Chen, P. Y., Hung, C. H., Gharpurey, R. & Akinwande, D. A zero power harmonic transponder sensor for ubiquitous wireless μL liquid-volume monitoring. Sci. Rep. 6, 18795 (2016).
9. Yvanoff, M. & Venkataraman, J. A feasibility study of tissue characterization using LC sensors. IEEE Trans. Antenna Propagat. 57, 885-893 (2009). 10. Bender, C. M. & Boettcher, S. Real spectra in non-Hermitian Hamiltonians having P T symmetry. Phys. Rev. Lett. 80, 5243 (1998).
11. Makris, K. G., El-Ganainy, R., Christodoulides, D. N. & Musslimani, Z. H. Beam dynamics in PT symmetric optical lattices. Phys. Rev. Lett. 100, 103904 (2008).
12. Ritter, Ch. E. et al. Observation of parity-time symmetry in optics. Nat. Phys. 6, 192-195 (2010).
13. Regensburger, A. et al. Parity-time synthetic photonic lattices. Nature 488, 167-171 (2012).
14. Lin, Z. et al. Unidirectional invisibility induced by PT-symmetric periodic structures. Phys. Rev. Lett. 106, 213901 (2011).
15. Mostafazadeh, A. Invisibility and PT symmetry. Phys. Rev. A 87, 012103 (2013).
16. Longhi, S. PT-symmetric laser absorber. Phys. Rev. A 82, 031801 (2010).
17. Chong, Y. D., Ge, L. & Stone, A. D. PT-symmetry breaking and laserabsorber modes in optical scattering systems. Phys. Rev. Lett. 106, 093902 (2011).
18. Feng, L., Wong, Z. J., Ma, R. M., Wang, Y. & Zhang, X. Single-mode laser by parity-time symmetry breaking. Science 346, 972-975 (2014).
19. Hodaei, H., Miri, M. A., Heinrich, M., Christodoulides, D. N. & Khajavikhan, M. Parity-time-symmetric microring lasers. Science 346, 975-978 (2014).
20. Wong, Z. J. et al. Lasing and anti-lasing in a single cavity. Nat. Photon. 10, 796-801 (2016).
21. Lee, J. M. et al. Reconfigurable directional lasing modes in cavities with generalized PT symmetry. Phys. Rev. Lett. 112, 253902 (2014).
22. Peng, B. et al. Parity-time-symmetric whispering-gallery microcavities. Nat. Phys. 10, 394-398 (2014).
23. Ramezani, H., Kottos, T., El-Ganainy, R. & Christodoulides, D. N. Unidirectional nonlinear PT-symmetric optical structures. Phys. Rev. A 82,
043803 (2010).
24. Chang, L. et al. Parity-time symmetry and variable optical isolation in active-passive-coupled microresonators. Nat. Photon. 8, 524-529 (2014).
25. Schindler, J., Li, A., Zheng, M. C., Ellis, F. M. & Kottos, T. Experimental study of active LRC circuits with PT symmetries. Phys. Rev. A 84, 040101 (2011).
26. Schindler, J. et al. PT-symmetric electronics. J. Phys. A 45, 444029 (2012).
27. Bender, N. et al. Observation of asymmetric transport in structures with active nonlinearities. Phys. Rev. Lett. 110, 234101 (2013).
28. Fleury, R., Sounas, D. & Alù, A. An invisible acoustic sensor based on parity-time symmetry. Nat. Commun. 6, 5905 (2015).
29. Lu, X. Y., Jing, H., Ma, J. Y. & Wu, Y. PT-symmetry-breaking chaos in optomechanics. Phys. Rev. Lett. 114, 253601 (2015).
30. Xu, X. W., Liu, Y. X., Sun, C. P. & Li, Y. Mechanical PT symmetry in coupled optomechanical systems. Phys. Rev. A 92, 013852 (2015).
31. Wiersig, J. Sensors operating at exceptional points: general theory. Phys. Rev. A 93, 033809 (2016).
32. Chen, P. Y. & Jung, J. PT-symmetry and singularity-enhanced sensing based on photoexcited graphene metasurfaces. Phys. Rev. Appl. 5, 064018 (2016).
33. Liu, Z. P. et al. Metrology with PT-symmetric cavities: enhanced sensitivity near the PT-phase transition. Phys. Rev. Lett. 117, 110802 (2016).
34. Chen, W., Özdemir, S. K., Zhao, G., Wiersig, J. & Yang, L. Exceptional points enhance sensing in an optical microcavity. Nature 548, 192-196 (2017).
35. Hodaei, H. et al. Enhanced sensitivity at higher-order exceptional points. Nature 548, 187-191 (2017).

What is claimed is:

1. A sensor system comprising:
a sensor that includes a RLC tank having a first input impedance, the RLC tank including a first coupling inductor; and
a reader that includes a -RLC tank having a second input impedance, the -RLC tank including a second coupling inductor inductively coupled to the first coupling inductor, wherein the first input impedance multiplied by i is approximately equal to the complex conjugate of the second input impedance multiplied by i at one or more predetermined frequencies.

2. The sensor system of claim 1 wherein the RLC tank further includes a first variable capacitor or first variable resistor in series with the first coupling inductor.

3. The sensor system of claim 2 wherein the first variable capacitor is a physical or chemical sensitive capacitor or the first variable resistor is a physical or chemical sensitive resistor.

4. The sensor system of claim 2, wherein the RLC tank further includes a resistor and/or an effective resistance in series with the first coupling inductor and the first variable capacitor.

5. The sensor system of claim 2 wherein the -RLC tank further includes a second variable capacitor in series with the second coupling inductor.

6. The sensor system of claim 5 wherein the -RLC tank further includes a negative resistor and/or a device with negative equivalent resistance in series with the second coupling inductor and the second variable capacitor.

7. The sensor system of claim 6 wherein reader further includes an RF generator such that the sensor can be monitored by reflection via a reflection coefficient of generated RF signals from the reader.

8. The sensor system of claim 6 wherein the sensor system exhibits parity-time symmetry.

9. The sensor system of claim 1 wherein the first input impedance multiplied by i has a magnitude that is within 10 percent of a magnitude of the second input impedance.

10. The sensor system of claim 1 wherein the phase of the first input impedance multiplied by i is within 10 percent of −1 times the phase of second input impedance multiplied by i.

11. The sensor system of claim 1 wherein gain and load of the sensor system is balanced.

12. The sensor system of claim 11 wherein the gain is with 20 percent of the load.

13. The sensor system of claim 1 wherein the sensor system exhibits parity time symmetry and reciprocal scaling between the RLC tank and the -RLC tank.

14. The sensor system of claim 1 wherein the RLC tank includes a negative resistance component in series with the second coupling inductor.

15. The sensor system of claim 1 wherein the sensor is implantable in a subject.

16. The sensor system of claim 1 wherein the sensor system is a wireless sensor is positionable externally wearable to a subject.

17. The sensor system of claim 1 wherein the predetermined frequencies are eigenfrequencies of the sensor system.

18. The sensor system of claim 1 operates in the proximity of the exceptional point which appears in PT-symmetric non-Hermitian systems.

19. The sensor system of claim 1 has a superior sensitivity in terms of shifts in predetermined frequency when physical or chemical parameters of interest in or around the sensor are changed.

20. The sensor system of claim 1 has a high resolution due to large quality factor (Q-factor) measured in the reader.
